(19) United States
(12) Patent Application Publication
(10) Pub. No.: US 2025/0086455 A1
(43) Pub. Date: Mar. 13, 2025

(54) METHODS AND SYSTEMS FOR CONDITIONAL MUTUAL INFORMATION CONSTRAINED DEEP LEARNING

(71) Applicant: MULTICOM TECHNOLOGIES INC., Petersburg (CA)

(72) Inventors: En-hui YANG, Petersburg (CA); Shayan Mohajer HAMIDI, Waterloo (CA); Linfeng YE, Waterloo (CA); Renhao TAN, Waterloo (CA)

(21) Appl. No.: 18/829,437

(22) Filed: Sep. 10, 2024

Related U.S. Application Data
(60) Provisional application No. 63/537,935, filed on Sep. 12, 2023.

(51) Int. Cl. G06N 3/08

(52) U.S. Cl. CPC G06N 3/08

(57) ABSTRACT

A system, method and computer program product for training a deep neural network. The deep neural network can be trained using a learning process that is defined to optimize both an error function of the deep neural network as well as a network mapping function of the deep neural network. The network mapping function can represent a predicted label distribution geometry property of the deep neural network. This learning process can improve the accuracy of the trained deep neural network model as well as its robustness again adversarial attacks. Optimizing the network mapping function can also provide increased insight into the operation of the trained deep neural network model, which may promote increased interpretability of the trained model and thus encourage uptake of the trained model.

### CROSS-REFERENCE TO RELATED APPLICATIONS

This application claims the benefit of U.S. Provisional Application No. 63/537,935 filed on Sep. 12, 2023, which is incorporated by reference herein in its entirety.

### FIELD

This document relates to deep learning models. In particular, this document relates to systems and methods for training deep learning models.

### BACKGROUND

Deep neural networks (DNNs) have been applied in a wide range of applications, revolutionizing fields like computer vision, natural language processing, and speech recognition (see, for example, Y. LeCun, Y. Bengio, and G. Hinton, “Deep learning,” nature, vol. 521, no. 7553, pp. 436-444, 2015; and I. Goodfellow, Y. Bengio, and A. Courville, Deep learning. MIT press, 2016). Typically, a DNN consists of cascaded non-linear layers that progressively produce multi-layers of representations with increasing levels of abstraction, starting from raw input data and ending with a predicted output label. The success of DNNs is largely attributable to their ability to learn these multi-layers of representations as features from the raw data through a deep learning (DL) process.

### SUMMARY

The following summary is intended to introduce the reader to various aspects of the detailed description, but not to define or delimit any invention.

The present disclosure relates to systems, methods and computer program products for training a deep neural network. The deep neural network can be trained using a learning process that is defined to optimize both an error function of the deep neural network as well as a network mapping function of the deep neural network. The network mapping function can represent a predicted label distribution geometry property of the deep neural network. This learning process can improve the accuracy of the trained deep neural network model as well as its robustness against adversarial attacks. Optimizing the network mapping function can also provide increased insight into the operation of the trained deep neural network model, which may promote increased interpretability of the trained model (and in turn encourage uptake of applications using a deep neural network model trained using these methods).

In an aspect of this disclosure, there is provided a method of training a deep neural network, the deep neural network comprising a plurality of layers, the plurality of layers including a plurality of intermediate layers arranged between an input layer and an output layer, wherein the deep neural network is configured to output a predicted label in response to receiving an input value, the method comprising: inputting a plurality of training data samples into the input layer of the deep neural network, wherein the plurality of training data samples are contained within a training set used to train the deep neural network, wherein each training data sample comprises a training input value, each training input value has an associated true label, and each true label corresponds to a particular class from amongst a plurality of potential classes; and generating a trained deep neural network using the plurality of training data samples to iteratively optimize both an error function of the deep neural network and a network mapping function of the deep neural network, wherein the network mapping function is defined to represent at least one predicted label distribution geometry property of the predicted labels output by the deep neural network in response to receiving training input values having associated true labels for one or more classes of the plurality of potential classes in the training data samples.

The at least one predicted label distribution geometry property can include a network intra-class concentration value for the deep neural network.

The network intra-class concentration value can be defined based on a plurality of class-specific intra-class concentration values, and each class-specific intra-class concentration value can represent a relative concentration of the set of predicted labels output by the deep neural network in response to the deep neural network receiving as inputs a set of training input values each having the same associated true label for a specific class in the plurality of potential classes.

For each potential class, the class-specific intra-class concentration value can be determined based on a divergence between the set of predicted labels output by the deep neural network in response to the deep neural network receiving as inputs the set of training input values having the associated true label for that potential class and a centroid of the set of predicted labels.

The network intra-class concentration value can be defined as an average of the class-specific intra-class concentration values for the plurality of potential classes.

The at least one predicted label distribution geometry property can include a network inter-class separation value for the deep neural network.

The network inter-class separation value can be defined based on the cross-entropy between a plurality of predicted label value pairs, where each predicted label value pair includes a first predicted label value defined based on one or more first predicted labels output by the deep neural network in response to the deep neural network receiving as input one or more first training input values each having a first associated true label for a first specific class and a second predicted label value defined based on one or more second predicted labels output by the deep neural network in response to the deep neural network receiving as input one or more second training input values each having a second associated true label for a second specific class, where the first specific class is different from the second specific class.

The at least one predicted label distribution geometry property can include a network inter-class separation value and a network intra-class concentration value for the deep neural network, and the network mapping function can be defined using a ratio of the network intra-class concentration and the network inter-class separation.

The at least one predicted label distribution geometry property can be approximated based on an empirical distribution of training input value and label pairs in the plurality of training data samples.

The trained deep neural network model can be generated using an iterative optimization process that alternates between optimizing the error function and optimizing the network mapping function.

The deep neural network can include a plurality of weight parameters defining layer connections between each pair of adjacent layers in the plurality of layers, and optimizing the error function can include updating the plurality of weight parameters in response to inputting the plurality of training data samples into the input layer of the deep neural network.

The deep neural network can include a plurality of weight parameters defining layer connections between each pair of adjacent layers in the plurality of layers, and optimizing the network mapping function can include, for each class in the plurality of potential classes, updating the centroid of the set of predicted labels output by the deep neural network in response to inputting a subset of the training data samples having the associated true label corresponding to that class into the input layer of the deep neural network while maintaining the plurality of weight parameters fixed.

In an aspect of this disclosure, there is provided a computer program product for training a deep neural network, the deep neural network comprising a plurality of layers, the plurality of layers including a plurality of intermediate layers arranged between an input layer and an output layer, wherein the deep neural network is configured to output a predicted label in response to receiving an input value, the computer program product comprising a non-transitory computer readable medium having computer executable instructions stored thereon, the instructions for configuring one or more processors to perform a method of training the deep neural network, wherein the method comprises: inputting a plurality of training data samples into the input layer of the deep neural network, wherein the plurality of training data samples are contained within a training set used to train the deep neural network, wherein each training data sample comprises a training input value, each training input value has an associated true label, and each true label corresponds to a particular class from amongst a plurality of potential classes; and generating a trained deep neural network using the plurality of training data samples to iteratively optimize both an error function of the deep neural network and a network mapping function of the deep neural network, wherein the network mapping function is defined to represent at least one predicted label distribution geometry property of the predicted labels output by the deep neural network in response to receiving training input values having associated true labels for one or more classes of the plurality of potential classes in the training data samples.

The at least one predicted label distribution geometry property can include a network intra-class concentration value for the deep neural network.

The network intra-class concentration value can be defined based on a plurality of class-specific intra-class concentration values, and each class-specific intra-class concentration value can represent a relative concentration of the set of predicted labels output by the deep neural network in response to the deep neural network receiving as inputs a set of training input values each having the same associated true label for a specific class in the plurality of potential classes.

For each potential class, the class-specific intra-class concentration value can be determined based on a divergence between the set of predicted labels output by the deep neural network in response to the deep neural network receiving as inputs the set of training input values having the associated true label for that potential class and a centroid of the set of predicted labels.

The network intra-class concentration value can be defined as an average of the class-specific intra-class concentration values for the plurality of potential classes.

The at least one predicted label distribution geometry property can include a network inter-class separation value for the deep neural network.

The network inter-class separation value can be defined based on the cross-entropy between a plurality of predicted label value pairs, where each predicted label value pair includes a first predicted label value defined based on one or more first predicted labels output by the deep neural network in response to the deep neural network receiving as input one or more first training input values each having a first associated true label for a first specific class and a second predicted label value defined based on one or more second predicted labels output by the deep neural network in response to the deep neural network receiving as input one or more second training input values each having a second associated true label for a second specific class, where the first specific class is different from the second specific class.

The at least one predicted label distribution geometry property can include a network inter-class separation value and a network intra-class concentration value for the deep neural network, and the network mapping function can be defined using a ratio of the network intra-class concentration and the network inter-class separation.

The at least one predicted label distribution geometry property can be approximated based on an empirical distribution of training input value and label pairs in the plurality of training data samples.

The trained deep neural network model can be generated using an iterative optimization process that alternates between optimizing the error function and optimizing the network mapping function.

The deep neural network can include a plurality of weight parameters defining layer connections between each pair of adjacent layers in the plurality of layers, and optimizing the error function can include updating the plurality of weight parameters in response to inputting the plurality of training data samples into the input layer of the deep neural network.

The deep neural network can include a plurality of weight parameters defining layer connections between each pair of adjacent layers in the plurality of layers, and optimizing the network mapping function can include, for each class in the plurality of potential classes, updating the centroid of the set of predicted labels output by the deep neural network in response to inputting a subset of the training data samples having the associated true label corresponding to that class into the input layer of the deep neural network while maintaining the plurality of weight parameters fixed.

In an aspect of this disclosure, there is provided a system for training a deep neural network, the deep neural network comprising a plurality of layers, the plurality of layers including a plurality of intermediate layers arranged between an input layer and an output layer, wherein the deep neural network is configured to output a predicted label in response to receiving an input value, the system comprising: one or more processors; and one or more non-transitory storage mediums; wherein the one or more processors are configured to: input a plurality of training data samples into the input layer of the deep neural network, wherein the plurality of training data samples are contained within a training set used to train the deep neural network, wherein each training data sample comprises a training input value, each training input value has an associated true label, and each true label corresponds to a particular class from amongst a plurality of potential classes; generate a trained deep neural network using the plurality of training data samples to iteratively optimize both an error function of the deep neural network and a network mapping function of the deep neural network, wherein the network mapping function is defined to represent at least one predicted label distribution geometry property of the predicted labels output by the deep neural network in response to receiving training input values having associated true labels for one or more classes of the plurality of potential classes in the training data samples; and store the trained deep neural network in the one or more non-transitory storage mediums.

The one or more processors can be further configured to perform a method of training a deep neural network, where the method is described herein.

It will be appreciated by a person skilled in the art that an apparatus, computer program product, system, or method disclosed herein may embody any one or more of the features contained herein and that the features may be used in any particular combination or sub-combination.

These and other aspects and features of various examples will be described in greater detail below.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example of a system for training a deep neural network;

FIG. 2 shows an example diagram illustrating mappings from the label space to the input space of a deep neural network and from the input space to the output space of the deep neural network;

FIG. 3A is a flowchart illustrating an example method of generating a trained deep neural network;

FIG. 3B is a flowchart illustrating an example method for training a deep neural network model;

FIG. 4 shows an example plot of the error rate ∈* on the y-axis vs a normalized conditional mutual information value on the x-axis over the validation set of known DNNs trained on the CIFAR-100 dataset;

FIG. 5 shows an example plot illustrating the concentration and separation for a ResNet56 model trained to optimize the cross-entropy of the model and the concentration and separation for a ResNet56 model trained to optimize both the cross-entropy and a network mapping function of the model;

FIG. 6A shows a plot of an example evolution curve of a network intra-class concentration value over the course of training a ResNet56 model over CIFAR-100 using a training method that optimizes the cross-entropy of the model and a training method that optimizes both the cross-entropy and a network mapping function of the model;

FIG. 6B shows a plot of an example evolution curve of a network inter-class separation value (e.g. F) over the course of training a ResNet56 model over CIFAR-100 using a training method that optimizes the cross-entropy of the model and a training method that optimizes both the cross-entropy and a network mapping function of the model;

FIG. 6C shows a plot of an example evolution curve of a normalized conditional mutual information value over the course of training a ResNet56 model over CIFAR-100 using a training method that optimizes the cross-entropy of the model and a training method that optimizes both the cross-entropy and a network mapping function of the model;

FIG. 6D shows a plot of an example evolution curve of an error rate (e.g. ∈*) over the course of training a ResNet56 model over CIFAR-100 using a training method that optimizes the cross-entropy of the model and a training method that optimizes both the cross-entropy and a network mapping function of the model;

FIG. 7A shows an example plot of the robustness of a deep neural network over the MNIST dataset against FGSM attack when the model is trained using a training method that optimizes the cross-entropy of the model and a training method that optimizes both the cross-entropy and a network mapping function of the model; and

FIG. 7B shows an example plot of the robustness of a deep neural network over the MNIST dataset against PGD attack with 5 iterations when the model is trained using a training method that optimizes the cross-entropy of the model and a training method that optimizes both the cross-entropy and a network mapping function of the model.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are systems, methods and computer program product for training deep learning models. The systems, methods and computer program products described herein can be used to train deep learning models to improve robustness and interpretability while achieving a high-level of model accuracy.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object oriented programming. Accordingly, the program code may be written in any suitable programming language such as Python or C for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates to systems, methods, and computer program products for training deep learning models. The systems, methods and computer program products described herein can provide a high-level of accuracy expected of deep learning models across different types of data distributions and provide increased robustness against adversarial attacks. The systems, methods and computer program products described herein may also enhance the interpretability of the results generated by a deep learning model by accounting for output prediction distribution geometry properties when training the model. This may improve the accuracy of the trained models across data sets with different data distributions and encourage increased uptake of applications implementing those models once trained.

A classification deep neural network (DNN) model can be considered as a mapping from raw data x∈ [symbol] ^{d} to a probability distribution qₓ over a set of class labels (a plurality of potential labels), predicting an output label y corresponding to a particular potential class with a probability qₓ(ŷ). That is, the deep neural network model outputs a predicted label ŷ in response to receiving an input value x. The predicted label can be output in various forms, e.g. as a top-1 predicted label value, a plurality of predicted label values and associated probabilities etc.

Given a pair of random variables (X,Y), the distribution of which governs either a training set or testing set, where X∈ [symbol] ^{d} represents raw input data and Y is the ground truth label of X (i.e. the correct or true label for the data sample(s) in X), the prediction performance of the DNN can be measured by its error rate

$$ϵ = Pr \{ \hat{Y} \neq Y \} ,$$

where Ŷ is the predicted label output by the DNN with a predicted label probability q_{X}(Ŷ) in response to receiving the input value or input sample X. The accuracy of the DNN is equal to 1−∈. The error rate can be further upper bounded by the average of the cross entropy between the conditional distribution of the true label Y given the input value X and the predicted label distribution q_{X}. To have better prediction performance, a learning process is typically applied to the DNN (i.e. to train the DNN) to minimize the error rate ∈ or its cross entropy upper bound.

Although the error rate of a DNN is considered the most important performance as far as prediction is concerned, focusing solely or entirely on the error rate can lead to several problems. For instance, the error rate of a DNN depends not only on the DNN itself, but also on the governing joint distribution of the training data samples or testing data samples (X,Y). When a DNN has a small error rate for one governing joint distribution of input data samples (X,Y), it does not necessarily imply that it would have a small error rate for another governing joint distribution of input data samples (X,Y), especially when the distributions are quite different. This is related to well-known overfitting and robustness problems (see, for example I. Goodfellow, Y. Bengio, and A. Courville, Deep learning. MIT press, 2016; I. J. Goodfellow, J. Shlens, and C. Szegedy, “Explaining and harnessing adversarial examples,” arXiv preprint arXiv:1412.6572, 2014; N. Carlini and D. Wagner, “Towards evaluating the robustness of neural networks,” in 2017 ieee symposium on security and privacy (sp). Ieee, 2017, pp. 39-57; and A. Madry, A. Makelov, L. Schmidt, D. Tsipras, and A. Vladu, “Towards deep learning models resistant to adversarial attacks,” in International Conference on Learning Representations, 2018).

Even when a DNN works well across different governing distributions of (X,Y), it remains a block box especially when the architecture of the DNN is large. It is not known why the DNN works or how the DNN works. The error rate does not reveal any useful information about the intrinsic mapping structure of the DNN and does not provide insight into predicted label distribution geometry properties such as the intra-class concentration and inter-class separation of the labels predicted by the DNN in its output space.

The inventors have found that applying information quantities from information theory (see, for example, T. M. Cover, Elements of information theory. John Wiley & Sons, 1999) to measure intra-class concentration and inter-class separation of the DNN can provide insight into the intrinsic mapping structure of a DNN as a mapping from an input value x∈ [symbol] ^{d} to a predicted label probability distribution qₓ.

A network intra-class concentration value can be used as a predicted label distribution geometry property for the deep neural network. For instance, the conditional mutual information (CMI) I(X; Ŷ|Y) between the input values X and the predicted labels Ŷ given the true label Y can be used as a measure of the intra-class concentration for a given class (corresponding to the true label Y) of the DNN as a mapping from the input value to the predicted label (i.e. x∈ [symbol] ^{d}→qₓ).

The class-specific intra-class concentration value for a potential class label y is determined based on the input samples/values x having an associated true label in that specific class y. The DNN maps this subset of input samples x into a set or cluster of predicted label distributions qₓ in the output probability distribution space. The conditional mutual information I(X; Ŷ|Y=y) between the set of input values/samples X and the predicted labels f for the associated true label Y=y represents how the predicted label probability distributions qₓ in the cluster/set of predicted label distributions are concentrated around the “centroid” (the conditional probability distribution P_{Ŷ|Y}(⋅|y)).

A smaller intra-class concentration value I(X; Ŷ|Y=y) indicates that the predicted label distributions qₓ in the cluster/set of predicted label distributions corresponding to input values with the same associated true label Y for a specific class y (i.e. Y=y) are more concentrated around the centroid of those predicted label distributions. The class-specific intra-class concentration value for all of the potential class labels can be used to determine a network intra-class concentration value for the DNN as a whole.

An inter-class separation value can be used as a predicted label distribution geometry property for the deep neural network based on a representation of the DNN as a mapping x∈ [symbol] ^{d}→qₓ.

A network mapping function can be defined based on the intra-class concentration and/or the inter-class separation of the DNN. The network mapping function (and associated predicted label distribution geometry properties) can provide insight into the mapping structure traits of the DNN, which can increase the interpretability of the DNN. For example, a ratio between the intra-class concentration (e.g. I(X; Ŷ|Y)) and the inter-class separation can be defined as the normalized conditional mutual information (NCMI) between the set of input values/samples X and the predicted labels Ŷ for the associated true label Y.

The present disclosure provides systems and methods for training a deep neural network to optimize a network mapping function in addition to an error function. This can result in a trained deep neural network that provides high levels of accuracy and can also improve the robustness and interpretability of the trained DNN.

In the systems and methods described herein, the standard deep learning (DL) framework can be modified to minimize an error function (e.g. the error rate or the standard cross entropy function) while also accounting for a network mapping function. For instance, the deep learning framework can be modified to optimize the error function subject to a network mapping function constraint (which may be referred to as CMI constrained deep learning or CMIC-DL). That is, a deep neural network can be trained using a learning process that optimizes both the error rate function as well as a network mapping function of the deep neural network.

The constrained learning process can be reframed into an alternating learning process in which the deep neural network model is trained using an iterative optimization process that alternates between optimizing the error function and optimizing the network mapping function. This can simplify the computational process of optimizing the deep neural network for both the error function and the network mapping function.

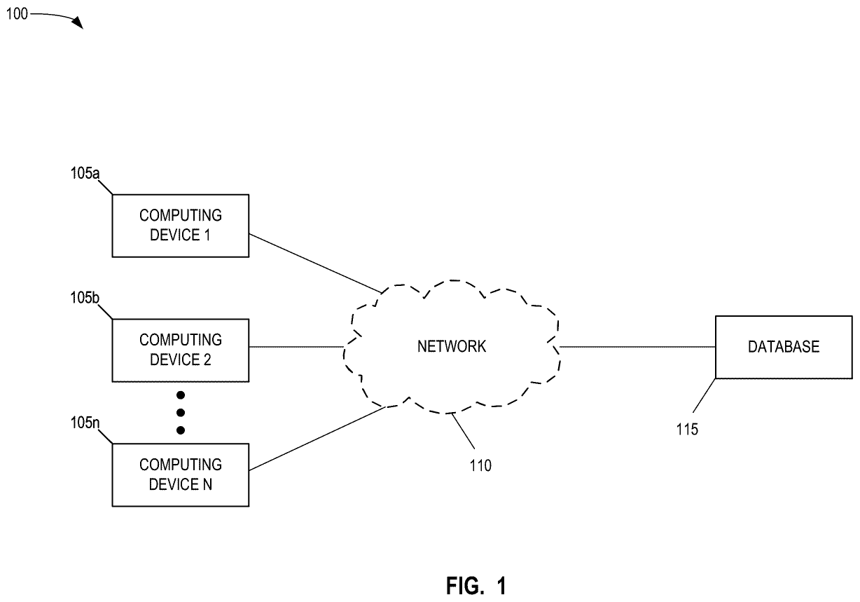

Referring now to FIG. 1, shown therein is a block diagram illustrating an example model training system 100. In the example illustrated, system 100 includes a plurality of training computing devices 105a-105n. One or more computing devices 105 can be configured to perform a method of training a deep learning model, such as the example methods 200 and 230 described in further detail herein below.

Each computing devices 105 can be implemented using one or more processors such as general purpose microprocessors. The processor(s) control the operation of the computing device 105 and in general can be any suitable processor such as a CPU, GPU, microprocessor, controller, digital signal processor, field programmable gate array, application specific integrated circuit, microcontroller, or other suitable computer processor that can provide sufficient processing power processor depending on the desired configuration, purposes and requirements of the system 100.

Computing device 105 can include the processor(s), a power supply, memory, and a communication module operatively coupled to the processor.

The memory unit can include both transient and persistent data storage elements, such as RAM, ROM, one or more hard drives, one or more flash drives or some other suitable data storage elements such as disk drives, etc.

As shown in FIG. 1, the computing devices 105 can be connected to one another through a network 110. The network 110 can communicatively couple the computing devices 105 to one another, e.g. using a wired or wireless communication protocol (e.g., Bluetooth, Bluetooth Low-Energy, WiFi, ANT+IEEE 802.11, etc.). The computing devices 105 can also be communicatively coupled over, for example, a wide area network such as the Internet.

Alternatively or in addition, the computing devices 105 can be coupled directly to one another, e.g. using a wired connection such as Universal Serial Bus (USB) or other port.

The computing devices 105 can be configured to communicate with one another to transmit data relating to training and/or storing a deep learning model. For example, the computing devices 105 may be configured to train a deep learning model individually or in parallel. Accordingly, the computing devices 105 can be configured to transmit various types of data (e.g. weight data, activation data, gradient data, predicted label distribution data) therebetween during the process of training and/or storing a deep learning model.

The trained neural network model may be stored in non-transitory memory accessible to one or more of the computing devices 105. The particular parameters (e.g. hyper-parameter values) and training (e.g. mini-batches, training epochs etc.) of the deep neural network model can vary depending on the architecture of the model and/or the particular application for which the deep learning model is being trained.

Optionally, system 100 can include a database 115. The database 115 can include suitable data storage elements for persistent data storage. The database 115 can store various different types of data that may be usable by the computing devices 105, such as parameters of a deep neural network model, trained model weights, training datasets, predicted label distributions, and so forth. Although database 115 is shown separately from the computing devices 105, it should be understood that database 115 may be co-located with, and/or integrated with, one or more of the computing devices 105.

A deep neural network model can be represented by its neural architecture having a plurality of layers including a plurality of intermediate layers arranged between an input layer and an output layer. The layers can be connected using layer connection weights (also referred to as weight parameters), the number of which can be in billions. These layer connection weights can be initialized, updated, and optimized through a learning process applied to the deep neural network.

A deep neural network model can also be represented as a mathematical mapping from an input value x∈ [symbol] ^{d} to a predicted label distribution/value qₓ. Evaluating the DNN from the perspective of a mapping x∈ [symbol] ^{d}→qₓ enables predicted label distribution geometry properties such as the intra-class concentration and inter-class separation to be considered during training of the DNN. This can further enhance the robustness and interpretability of the deep neural network model, by accounting for the mapping structure of the model during training.

The following notation will be used to facilitate the discussion herein. For a positive integer K, let [K] [symbol] {1, . . . , K}. The set of potential class labels (i.e. the plurality of potential classes) can be represented by [C], where the set of potential class labels includes C class labels (i.e. C is the number of potential class labels in the set of class labels [C]). P([C]) can denote the set of all predicted label probability distributions over the set of potential class labels [C]. For any two probability distributions in the set of predicted label probability distributions (i.e. for any two q₁, q₂∈P([C])), the cross-entropy (CE) of those probability distributions q₁ and q₂ can be defined as:

$$H ( {q}_{1} , {q}_{2} ) = {\sum }_{i = 1}^{C} - {q}_{1} ( i ) ln {q}_{2} ( i ) , \qquad ( 1 )$$

where ln denotes the logarithm with base e.

The Kullback-Leibler (KL) divergence (or relative entropy) between the pair of probability distributions q₁ and q₂ can be defined as:

$$D ( {q}_{1} ‖ {q}_{2} ) = {\sum }_{i = 1}^{C} {q}_{1} ( i ) ln \frac{{q}_{1} ( i )}{{q}_{2} ( i )} \qquad ( 2 )$$

For any specific class y in the set of potential classes [C](i.e. for any y∈[C]) and any predicted label distribution q in the set of predicted label distributions P([C]) (i.e. any q∈P([C])), the CE of the one-hot probability distribution corresponding to that class y and that probability distribution q can be defined as

$$H ( y , q ) = - ln q ( y ) \qquad ( 3 )$$

For any random vector (X,Y) containing one or more input values X and a corresponding true label Y, the joint probability distribution of that random vector can be denoted by P_{XY}(x,y) (or simply P(x,y) whenever there is no ambiguity). The marginal distributions of the random vector (X,Y) can be denoted by P_{X}(x) and P_{Y}(y) respectively (or simply P(x) and P(y) respectively whenever there is no ambiguity). For the random vector (X,Y), the conditional distribution of the true label Y given X=x can be represented by P_{Y|X}(⋅|x), and the conditional distribution of the input value X given Y=y can be represented by P_{X|Y}(⋅|y).

For a DNN with a mapping x∈ [symbol] ^{d}→qₓ, θ can denote the weight vector of the DNN consisting of all its connection weights (i.e. θ can represent the plurality of weight parameters of the DNN). Whenever there is no ambiguity, the distribution qₓ can also be represented by q_{x,θ}, and qₓ(y) can also be represented by q(y|x,θ) for any y∈[C]. If Y takes values in [C], then for any x, H(P_{Y|X}(⋅|x), qₓ) is well defined and equal to the CE of the distributions P_{Y|X}(⋅|x) and qₓ.

For a DNN that defines a mapping x∈ [symbol] ^{d}→qₓ and a pair of random variables (X,Y) representing the raw input data and the corresponding ground truth label, Ŷ can represent the label predicted by the DNN (i.e. the predicted label output by the DNN) with a predicted label probability qₓ(Ŷ) in response to receiving the input value/sample X. For any input sample x∈ [symbol] ^{d} and any predicted label in one of the potential classes (i.e. any ŷ∈[C]), the conditional distribution of the predicted label can be represented by

$${P}_{\hat{Y} \vert X} ( \hat{y} \vert x ) = {q}_{x} ( \hat{y} ) = q ( \hat{y} \vert x , θ ) \qquad ( 4 )$$

As can be seen from the above, Y→X→Ŷ forms a Markov chain in the indicated order. Therefore, given a particular input value X=x, the true label Y and predicted label Ŷ are conditionally independent.

The error rate ∈ of the DNN for (X,Y) is equal to the probability that the predicted label Ŷ output by the DNN does not equal the true label Y:

$$ϵ = Pr \{ \hat{Y} \neq Y \}$$

The error rate can be upper bounded by the average of the CE of the conditional probability distribution of the true label Y given the input sample X, the conditional distribution of the true label P_{Y|X}(⋅|X), and the predicted label distribution qₓ, as shown below.

For any DNN: x∈ [symbol] ^{d}→qₓ and any (X,Y),

$$ϵ \leq {E}_{X} [ H ( {P}_{Y \vert X} ( \cdot \vert X ) , {q}_{X} ) ] = {\sum }_{x} {P}_{X} ( x ) H ( {P}_{Y \vert X} ( \cdot \vert x ) , {q}_{x} ) , \qquad ( 5 )$$

where E_{X} denotes the expectation with respect to X (the summation over x can be replaced by the corresponding integral if X is continuous).

To illustrate the upper bounding of the error rate, let I_{{Ŷ≠Y}} denote the indicator function of the event {Ŷ≠Y}. Then

$$ϵ = Pr \{ \hat{Y} \neq Y \}$$

$$= E [ {I}_{\{ \hat{Y} \neq Y \}} ]$$

$$= {E}_{X} [ E [ {I}_{\{ \hat{Y} \neq Y \}} \vert X ] ]$$

$$= {E}_{X} [ 1 - {\sum }_{i = 1}^{C} {P}_{Y \vert X} ( i \vert X ) {P}_{\hat{Y} \vert X} ( i \vert X ) ] \qquad ( 6 )$$

$$= {E}_{X} [ 1 - {\sum }_{i = 1}^{C} {P}_{Y \vert X} ( i \vert X ) {q}_{X} ( i ) ] \qquad ( 7 )$$

$$= {E}_{X} [ {\sum }_{i = 1}^{C} {P}_{Y \vert X} ( i \vert X ) ( 1 - {q}_{X} ( i ) ) ]$$

$$\leq {E}_{X} [ {\sum }_{i = 1}^{C} - {P}_{Y \vert X} ( i \vert X ) ln {q}_{X} ( i ) ] \qquad ( 8 )$$

$$= {E}_{X} [ H ( {P}_{Y \vert X} ( \cdot \vert X ) , {q}_{X} ) ] , \qquad ( 9 )$$

where (6) follows from the fact that the true label Y and the predicted label Ŷ are conditionally independent given the input sample X, (7) is attributable to (4), and (8) is due to the inequality lnz≤z−1 for any z>0.

Alternatively, the DNN can be defined to output the top one label Ŷ* in response to receiving the input data X=x, where

$${\hat{Y}}^{*} = arg {max}_{i ∈ [ C ]} {q}_{x} ( i ) ?$$

In this case, the error rate of the DNN for (X,Y) can be defined as

$${ϵ}^{*} = Pr \{ {\hat{Y}}^{*} \neq Y \} ,$$

which can also be upper bounded in terms of E_{X}[H(P_{Y|X}(⋅|X), qₓ)].

For any DNN: x∈ [symbol] ^{d}→qₓ and any (X,Y),

$$\begin{matrix}{ϵ}^{*} \leq Cϵ \leq C & {E}_{X} [ H ( {P}_{Y \vert X} ( \cdot \vert X ) , {q}_{X} ) ] .\end{matrix} \qquad ( 10 )$$

This can be shown by

$${ϵ}^{*} = Pr \{ {\hat{Y}}^{*} \neq Y \} \qquad ( 11 )$$

$$= {E}_{X} [ 1 - {P}_{Y \vert X} ( {\hat{Y}}^{*} \vert X ) ]$$

$$\leq {CE}_{X} [ {q}_{x} ( {\hat{Y}}^{*} ) ( 1 - {P}_{Y \vert X} ( {\hat{Y}}^{*} \vert X ) ) ]$$

$$\leq C {E}_{X} [ {\sum }_{i = 1}^{C} {q}_{x} ( i ) ( 1 - {P}_{Y \vert X} ( i \vert X ) ) ] \qquad ( 12 )$$

$$= C {E}_{X} [ 1 - {\sum }_{i = 1}^{C} {P}_{Y \vert X} ( i \vert X ) {q}_{X} ( i ) ]$$

$$= C ϵ \leq {CE}_{X} [ H ( {P}_{Y \vert X} ( \cdot \vert X ) , {q}_{X} ) ] ,$$

where (11) follows from the fact that qₓ(Ŷ*)≥1/C, and (12) is due to (7) and (9).

In view of the above, no matter which form of error rate ∈ or ∈* is used, minimizing the average of the cross entropy E_{X}[H(P_{Y|X}(⋅|X), qₓ)] also operates to reduce the error rate ∈ and ∈*. Accordingly, the average of the cross entropy E_{X}[H(P_{Y|X}(⋅|X), qₓ)] can be used as an objective function (or a major component thereof) in a deep learning and/or knowledge distillation process, where P_{Y|X} is approximated by the one-hot probability vector corresponding to the true label Y in deep learning (DL), and by the output probability distribution of the teacher in a knowledge distillation process (see, for example, G. E. Hinton, O. Vinyals, and J. Dean, “Distilling the knowledge in a neural network,” in NIPS Deep Learning and Representation Learning Workshop, 2015; K. Zheng and E.-H. Yang, “Knowledge distillation based on transformed teacher matching,” in International Conference on Learning Representations, ICLR, 2024; and A. K. Menon, A. S. Rawat, S. Reddi, S. Kim, and S. Kumar, “A statistical perspective on distillation,” in International Conference on Machine Learning. PMLR, 2021, pp. 7632-7642).

As noted above, the error rates E and E* of the DNN: x∈ [symbol] ^{d}→qₓ for (X,Y) do not provide any useful information about the intrinsic mapping structure of the DNN in the probability distribution space P([C]). Examples of important mapping structure properties (also referred to as predicted label distribution geometry properties) of the DNN: x∈ [symbol] ^{d}→qₓ are the intra-class concentration and inter-class separation in the space P([C]).

### Example Intra-Class Concentration Function

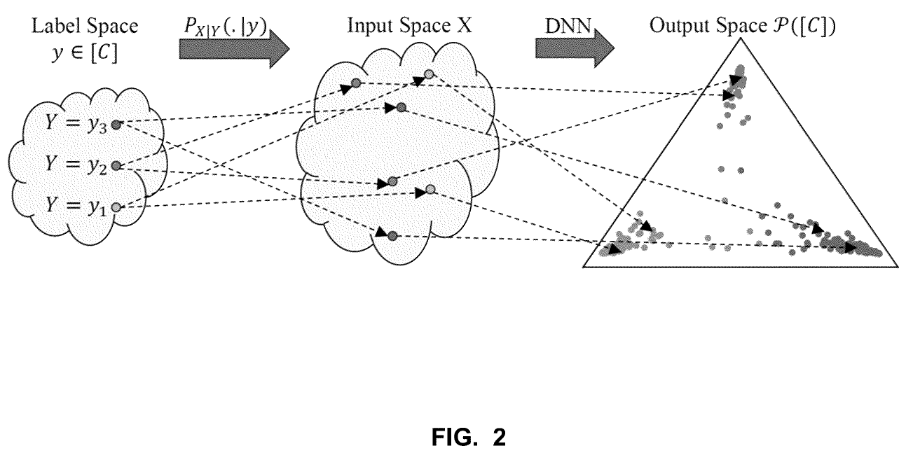

FIG. 2 shows an exemplary illustration of the label and input spaces in which three label instances in the label space have each been mapped to two input value instances in the input space according to P_{X|Y}(⋅|yᵢ), for i∈{1,2,3}. The output space is a visualization of the output probability vector corresponding to all validation sample instances from three randomly picked potential classes projected over the two-dimensional probability simplex for a ResNet56 model trained on the CIFAR-100 dataset.

For a DNN that defines the classification mapping x∈ [symbol] ^{d}→qₓ as represented in FIG. 2 and given a specific true label Y=y, y∈[C], the input data X is conditionally distributed according to the conditional distribution P_{X|Y}(⋅|y) and then mapped into a predicted label distribution qₓ, a random point in the output space P([C]). The instances (or realizations) of this random point qₓ form a cluster (a set of predicted labels) corresponding to the class y in the space P([C]). The centroid s_{y} of this cluster is the average of the predicted label output values/distributions qₓ with respect to the conditional distribution P_{X|Y}(⋅|y)

$${s}_{y} {=}^{Δ} {\sum }_{x} {P}_{X \vert Y} ( x \vert y ) {q}_{x} \qquad ( 13 )$$

$$= {\sum }_{x} {P}_{X \vert Y} ( x \vert y ) {P}_{\hat{Y} \vert X} ( \cdot \vert x ) = {P}_{\hat{Y} \vert Y} ( \cdot \vert y ) , \qquad ( 14 )$$

where (14) is due to (4) and the Markov chain Y→X→Y.

The “distance” between each predicted label value qₓ in the cluster (set of predicted label values) and the centroid s_{y} of the cluster can be measured by the KL divergence D(qₓ∥s_{y}). That is, for each potential class, a class-specific intra-class concentration value can be determined based on a divergence between the set of predicted labels output by the deep neural network in response to the deep neural network receiving as inputs a set of input values having the associated true label for that potential class and a centroid of the set of predicted labels.

The average KL divergence D(qₓ∥s_{y}) within the cluster with respect to the conditional distribution P_{X|Y}(⋅|y) (i.e. determining an average divergence from the centroid for the set of predicted labels) can determined according to:

$$E [ D ( {q}_{X} ‖ {s}_{y} ) \vert Y = y ] \qquad ( 15 )$$

$$= {\sum }_{x} {P}_{X \vert Y} ( x \vert y ) [ {\sum }_{i = 1}^{C} {q}_{x} ( i ) ln \frac{{q}_{x} ( i )}{{s}_{y} ( i )} ]$$

$$= {\sum }_{x} {P}_{X \vert Y} ( x \vert y ) [ {\sum }_{i = 1}^{C} {P}_{\hat{Y} \vert X} ( i \vert x ) ln \frac{{P}_{\hat{Y} \vert X} ( i \vert x )}{{P}_{\hat{Y} \vert Y} ( i \vert y )} ]$$

$$= {\sum }_{x} {P}_{X \vert Y} ( x \vert y ) [ {\sum }_{i = 1}^{C} {P}_{\hat{Y} \vert XY} ( i \vert x , y ) ln \frac{{P}_{\hat{Y} \vert XY} ( i \vert x , y )}{{P}_{\hat{Y} \vert Y} ( i \vert y )} ] \qquad ( 16 )$$

$$= I ( X ; \hat{Y} \vert y ) , \qquad ( 17 )$$

where I(X; Ŷ|y) is the conditional mutual information between X and Ŷ given Y=y. (Please refer to T. M. Cover, Elements of information theory. John Wiley & Sons, 1999 for the notions of mutual information and conditional mutual information.) In the above, (15) is due to (4) and (14); (16) follows from the Markov chain Y→X→Ŷ.

The value I(X; Ŷ|y) quantifies the concentration of the cluster corresponding to a particular class Y=y in the set of potential classes (also referred to as the class-specific intra-class concentration). The class-specific intra-class concentration value represents a relative concentration of the set of predicted labels Ŷ output by the deep neural network in response to the deep neural network receiving as inputs a set of input values X each having the same associated true label Y for a specific class y in the plurality of potential classes [C].

A network intra-class concentration value for the entire DNN can be defined based on a plurality of class-specific intra-class concentration values for the plurality of potential classes. For example, the network intra-class concentration value can be defined as an average of the class-specific intra-class concentration values for the plurality of potential classes.

An average value of I(X; Ŷ|y) across all clusters with respect to the distribution P_{Y}(y) (i.e. an average of the class-specific intra-class concentration values for the plurality of potential classes) can be calculated to determine the conditional mutual information I(X; Ŷ|Y) between X and Ŷ given Y:

$$I ( X ; \hat{Y} \vert Y ) = {\sum }_{y ∈ [ C ]} {P}_{Y} ( y ) I ( X ; \hat{Y} \vert y ) \qquad ( 18 )$$

$$= E [ E [ D ( {q}_{X} ‖ {s}_{Y} ) \vert Y ] ] = E [ D ( {q}_{X} ‖ {s}_{Y} ) ]$$

$$= {\sum }_{y} {\sum }_{x} P ( x , y ) [ {\sum }_{i = 1}^{C} {q}_{x} ( i ) ln \frac{{q}_{x} ( i )}{{s}_{y} ( i )} ] . \qquad ( 19 )$$

The CMI value I(X; Ŷ|Y) can used as a measure for the intra-class concentration of the entire DNN: x∈ [symbol] ^{d}→qₓ for (X,Y) (also referred to as the network intra-class concentration).

In practice, the joint distribution P(x,y) may be unknown. Accordingly, the joint distribution P(x,y) may be approximated based on an empirical distribution from a plurality of data samples {(x₁,y₁), (x₂,y₂), . . . , (xₙ,yₙ)}(i.e. an empirical distribution of input value and label pairs). The intra-class concentration can then be approximated based on an empirical distribution of input value and label pairs in the plurality of data samples.

For the empirical approximation, the averages in (13) and (18) are replaced by the respective sample means. For each potential class in the plurality of potential classes y∈[C], the centroid can be determined from the empirical distribution according to

$${s}_{y} = \frac{1}{{n}_{y}} {Σ}_{( {x}_{j} , {y}_{j} ) : {y}_{j} = y} {q}_{{x}_{j} ,} \qquad ( 20 )$$

$$where$$

$${n}_{y} = \vert \{ j : {y}_{j} = y , 1 \leq j \leq n \} \vert , \qquad ( 21 )$$

and |S| denotes the cardinality of a set S, and the network intra-class concentration can be determined according to

$$I ( X ; \hat{Y} \vert Y ) = \frac{1}{n} {Σ}_{( {x}_{j} , {y}_{j} )} D ( {q}_{{x}_{j}} ‖ {s}_{{y}_{j}} ) = \frac{1}{n} {Σ}_{j = 1}^{n} D ( {q}_{{x}_{j}} ‖ {s}_{{y}_{j}} ) . \qquad ( 22 )$$

### Example Inter-Class Separation Function

The mapping structure of the DNN can also quantified using a predicted label distribution geometry property that reflects the separation between different clusters in the output space of the DNN (a network inter-class separation value).

A second pair of random variables (U,V) can be provided that are independent of (X,Y) and have the same joint distribution as that of (X,Y). With reference to FIG. 2, (X,Y) and (U,V) can be interpreted as two independent samples from a training (or testing) dataset. The inter-class separation of the DNN can be determined based on at least in part a measure of distance between predicted label values for different predicted label clusters (i.e. between predicted label values corresponding to input values for a first specific class and a second specific class that is different from the first specific class).

For example, the inter-class separation of the DNN: x∈ [symbol] ^{d}→qₓ can be represented by a first inter-class separation function:

$$Γ = E [ {I}_{\{ Y \neq V \}} H ( {q}_{X} , {q}_{U} ) ] \qquad ( 23 )$$

The first inter-class separation function can generate a network inter-class separation value based on the cross-entropy H between a plurality of predicted label value pairs (q_{X}, q_{U}). Each predicted label value pair (qₓ, q_{U}) includes a first predicted label value q_{X} defined based on one or more first predicted labels output by the deep neural network in response to the deep neural network receiving as input one or more first training input values each having a first associated true label Y for a first specific class and a second predicted label value q_{U} defined based on one or more second predicted labels output by the deep neural network in response to the deep neural network receiving as input one or more second training input values each having a second associated true label V for a second specific class.

It can be seen from first inter-class separation function of equation (23) that the larger Γ is, the further apart different clusters are from each other on average.

Other example inter-class separation functions will described in further detail below. The various example inter-class separation functions provide generally similar representations of the inter-class separation of the DNN. However, the first inter-class separation function Γ has been found to be more convenient for the selection of hyper parameters in the DNN training methods described herein. Unless indicated otherwise, the expectation E is with respect to the distribution or joint distribution of random variables appearing inside the brackets of E.

The mapping structure of the DNN can be represented by a network mapping function defined to represent at least one predicted label distribution geometry property of the predicted labels output by the deep neural network. In some examples, the at least one predicted label distribution geometry property can include both a network inter-class separation value and a network intra-class concentration value for the deep neural network. The network mapping function can then be defined based on both of the network intra-class concentration and the network inter-class separation.

In training a deep neural network, it may be desirable to maintain the intra-class concentration value I(X; Ŷ|Y) small (i.e. highly concentrated clusters) while keeping the inter-class separation value Γ large (i.e. different clusters are spaced far apart). Accordingly, the network mapping function may be defined using a ratio of the network intra-class concentration I(X; Ŷ|Y) and the network inter-class separation Γ, such as:

$$\hat{I} ( X ; \hat{Y} \vert Y ) {=}^{Δ} \frac{I ( X ; \hat{Y} \vert Y )}{Γ} \qquad ( 24 )$$

The ratio Î(X; Ŷ|Y) of the network intra-class concentration and the network inter-class separation can be referred to as the normalized conditional mutual information (NCMI) between X and Ŷ given Y.

As noted above, the joint distribution P(x,y) may be unknown in practice. Accordingly, the joint distribution P(x,y) may be approximated based on an empirical distribution from a plurality of data samples {(x₁,y₁), (x₂,y₂), . . . , (xₙ, yₙ)} (i.e. an empirical distribution of input value and label pairs). As with the intra-class concentration in (22), the network inter-class separation can be approximated based on an empirical distribution of input value and label pairs in the plurality of data samples.

For example, the inter-class separation Γ can be determined based on the plurality of data samples according to

$$Γ = \frac{1}{{n}^{2}} {\sum }_{j = 1}^{n} {\sum }_{k = 1}^{n} {I}_{\{ {y}_{j} \neq {y}_{k} \}} H ( {q}_{{x}_{j} ,} {q}_{{x}_{k}} ) , \qquad ( 25 )$$

The network mapping function Î(X; Ŷ|Y) can then be determined based on the empirical distribution from a data sample using equations (22) and (25).

Alternatively, there may be applications in which it is desirable to increase the intra-class concentration value (while maintaining a large inter-class separation value). For instance, when training a teacher model in a knowledge distillation process, it may be desirable to increase the intra-class concentration value to provide additional contextual information that can be used to train the student/distilled model. In such cases, the network mapping function can be modified to allow for the intra-class concentration value to be increased while maintaining a large inter-class separation value.

### Evaluation of Existing DNNs Using Predicted Label Distribution Geometry Properties

The inventors evaluated and compared popular DNNs pretrained in the literature over the ImageNet and CIFAR-100 datasets. The DNNs evaluated include ResNet-{18,34,50,101,152}(see K. He, X. Zhang, S. Ren, and J. Sun, “Deep residual learning for image recognition,” in Proceedings of the IEEE conference on computer vision and pattern recognition, 2016, pp. 770-778), ResNext-{50,101,152}(see S. Xie, R. Girshick, P. Doll'ar, Z. Tu, and K. He, “Aggregated residual transformations for deep neural networks,” in Proceedings of the IEEE conference on computer vision and pattern recognition, 2017, pp. 1492-1500), SqueezeNet (see F. N. Iandola, S. Han, M. W. Moskewicz, K. Ashraf, W. J. Dally, and K. Keutzer, “Squeezenet: Alexnet-level accuracy with 50× fewer parameters and! 0.5 mb model size,” arXiv preprint arXiv:1602.07360, 2016), Wide-ResNet-{40_2,16_2,40_1,16_1} (see S. Zagoruyko and N. Komodakis, “Wide Residual Networks,” in British Machine Vision Conference 2016. York, France: British Machine Vision Association, January 2016), Xception (see F. Chollet, “Xception: Deep learning with depthwise separable convolutions,” in Proceedings of the IEEE conference on computer vision and pattern recognition, 2017, pp. 1251-1258), MobileNet-{1,0.5,0.25} (see A. G. Howard, M. Zhu, B. Chen, D. Kalenichenko, W. Wang, T. Weyand, M. Andreetto, and H. Adam, “Mobilenets: Efficient convolutional neural networks for mobile vision applications,” arXiv preprint arXiv:1704.04861, 2017), and DenseNet121 (see G. Huang, Z. Liu, L. Van Der Maaten, and K. Q. Weinberger, “Densely connected convolutional networks,” in Proceedings of the IEEE conference on computer vision and pattern recognition, 2017, pp. 4700-4708). The evaluated DNNs have different architectures and different sizes.

The intra-class concentration, inter-class separation, network mapping function, and error rate for each DNN over the over CIFAR-100 and ImageNet datasets were evaluated. Table 1 shows the results of these experiments for various models trained using a standard cross-entropy optimization learning process.

TABLE 1
intra-class concentration (CMI), inter-class separation (Γ), NCMI, and error rate
values, over the validation set, of models trained with CE loss on the CIFAR-100 dataset

| | | | | Error | | | | | Error |
|---|---|---|---|---|---|---|---|---|---|
| Model | CMI | Γ | NCMI | rate ϵ* | Model | CMI | Γ | NCMI | rate ϵ* |
| ResNet18 | 0.837 | 11.389 | 0.073 | 0.239 | WRN16_1 | 1.125 | 11.001 | 0.102 | 0.414 |
| ResNet34 | 0.794 | 11.551 | 0.068 | 0.228 | WRN40_1 | 0.993 | 12.189 | 0.0814 | 0.324 |
| ResNet50 | 0.825 | 12.345 | 0.066 | 0.213 | WRN16_2 | 1.017 | 12.907 | 0.079 | 0.312 |
| ResNet101 | 0.774 | 12.151 | 0.064 | 0.209 | WRN40_2 | 0.934 | 12.716 | 0.073 | 0.264 |
| ResNet152 | 0.764 | 12.098 | 0.063 | 0.208 | Xception | 0.759 | 11.270 | 0.067 | 0.226 |
| ResNext50 | 0.792 | 11.967 | 0.066 | 0.213 | MobileNet-0.25 | 1.166 | 11.376 | 0.103 | 0.405 |
| ResNext101 | 0.774 | 12.151 | 0.065 | 0.206 | MobileNet-0.5 | 1.140 | 11.816 | 0.096 | 0.356 |
| ResNext 152 | 0.764 | 12.098 | 0.063 | 0.204 | MobileNet-1 | 1.036 | 11.729 | 0.088 | 0.327 |
| SqueezeNet | 1.084 | 12.377 | 0.087 | 0.307 | DenseNet121 | 0.752 | 11.703 | 0.064 | 0.209 |

Table 1 lists the values of CMI, Γ, and NCMI of the tested DNNs, which are calculated, according to (22), (25), and (24), over the CIFAR-100 validation set, along with their respective error rate ∈*. In Table 1, models within the same family are listed in the order of increasing model size. As the model size within the same family increases, it can be seen from Table 1 that: (1) there is no clear increasing or decreasing trend in either the CMI or Γ value; and (2) the NCMI value always decreases.

Table 1 also illustrates that within the same family, as the NCMI value decreases, so does the error rate ∈*. This relationship remains valid in general even across all models evaluated. As shown in Table 1 above, the validation accuracies of the tested DNNs are more or less inversely proportional to their NCMI values. Even though the tested DNNs have different architectures and different sizes, their error rates and NCMI values have more or less a positive linear relationship.

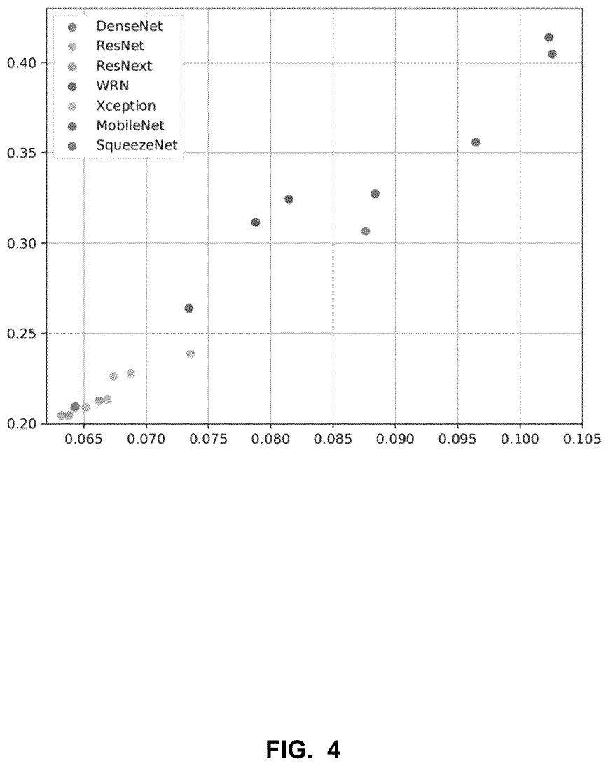

FIG. 4 illustrates a plot of the NCMI and error rate ∈* results from Table 1 showing the relationship between the NCMI and error rate ∈* graphically. As can be seen from the plot in FIG. 4, the NCMI and error rate ∈* have a positive linear relationship; indeed, the Pearson correlation coefficient ρ (see I. Cohen, Y. Huang, J. Chen, J. Benesty, J. Benesty, J. Chen, Y. Huang, and I. Cohen, “Pearson correlation coefficient,” Noise reduction in speech processing, pp. 1-4, 2009) between the error rate and NCMI was found to be above 0.98 for the CIFAR-100 dataset and above 0.99 for the ImageNet dataset. As such, the NCMI value of a DNN can be used to gauge the prediction performance of the DNN.

The predicted label distribution geometry properties described herein (e.g. CMI, Γ, and/or NCMI) can be used as additional performance metrics for any DNN. These additional performance metrics are in parallel with the error rate performance metric, are independent of any learning process, and represent mapping structure properties of a DNN. As additional performance metrics, they can be used to evaluate and compare different DNNs regardless of the architectures and sizes of DNNs.

### Example Methods of Training a DNN

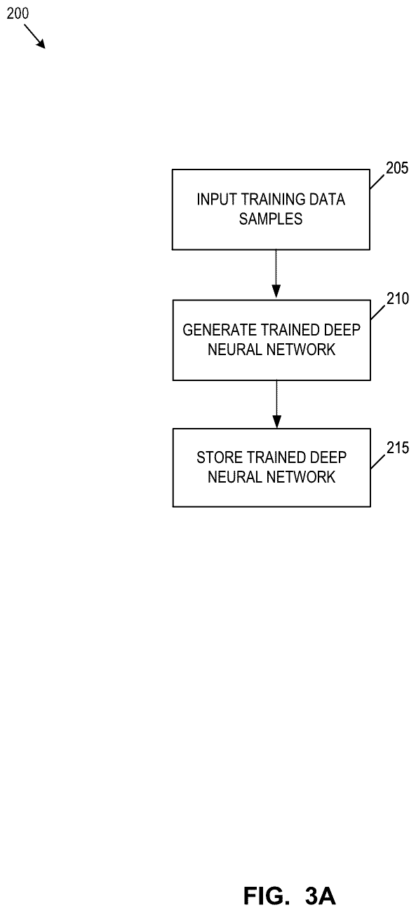

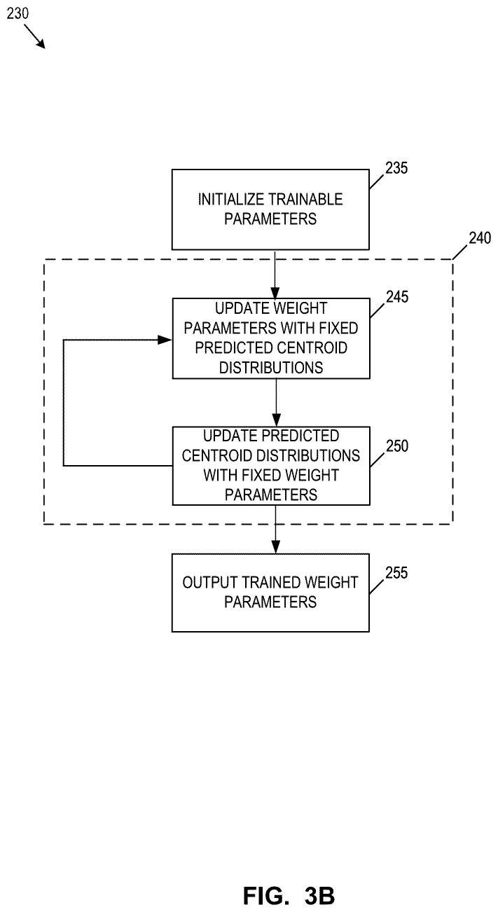

Referring now to FIG. 3A, shown therein is an example method 200 for generating a trained deep neural network. The method 200 may be used with a model training system such as system 100 for example. Method 200 is an example of a method for training a deep neural network that may improve robustness and interpretability while retaining or improving a high level of model accuracy.

A deep neural network generally includes a plurality of layers arranged between an input layer and an output layer. The plurality of layers includes a plurality of intermediate layers arranged between the input layer and the output layer. Inputs are provided to the input layer and the deep neural network is configured to output a predicted label in response to receiving the input value. The deep neural network may output a predicted classification or probability distribution of classifications from the output layer identifying a predicted classification for the input value.

At 205 a plurality of training data samples can be input into the input layer of the deep neural network. The plurality of training data samples can be contained within a training set used to train the deep neural network.

Each training data sample can include a training input value. Each training input value has an associated true label. Each true label corresponds to a specific class from amongst a plurality of potential classes.

At 210, the trained deep neural network can be generated using the plurality of training data samples. Generating the trained deep neural network can include iteratively optimizing both an error function of the deep neural network and a network mapping function of the deep neural network.

The deep neural network can include a plurality of weight parameters defining layer connections between each pair of adjacent layers in the plurality of layers. The weight parameters can be optimized through an iterative optimization process to improve the performance (e.g. minimize the error function of the deep neural network).

The error function can be defined in various ways to represent an error value or rate reflecting the accuracy of the classifications output by the DNN (e.g. an error rate or cross entropy upper bound). The network mapping function can be defined to represent at least one predicted label distribution geometry property of the predicted labels output by the deep neural network in response to receiving training input values having associated true labels for one or more classes of the plurality of potential classes in the training data samples. For instance, the at least predicted label distribution geometry property can include an intra-class concentration value, an inter-class separation value and/or some combination thereof.

Simultaneously optimizing an error function and a network mapping function of a DNN during the learning process can further improve the effectiveness of the deep learning process. The error function can represent the prediction performance of the deep neural network while the network mapping function represents the concentration/separation mapping structure performance of the DNN.

For example, a combined optimization function [symbol] (λ,β,θ,{Q_{c}}_{c∈[C]}) can be defined to optimize the weight parameters θ of the deep neural network, the predicted centroid distributions {Q_{c}}_{c∈[C]}, and hyper-parameters λ and β of the deep neural network. An example combined optimization function can be defined as:

$${J}_{B} ( λ , β , θ , {\{ {Q}_{c} \}}_{c ∈ [ C ]} ) = \frac{1}{\vert ℬ \vert} {\sum }_{( x , y ) ∈ B} H ( y , {q}_{x , θ} ) + λ \frac{1}{\vert ℬ \vert} {\sum }_{( x , y ) ∈ B} D ( {q}_{x , θ} ‖ {Q}_{y} ) - β \frac{1}{\vert ℬ {\vert}^{2}} {\sum }_{( x , y ) , ( u , v ) ∈ B} {I}_{\{ y \neq v \}} H ( {q}_{x , θ} , {q}_{u , θ} ) . \qquad ( 26 )$$

A combined optimization function can be determined by modifying a standard deep learning objective function to minimize the standard cross entropy function subject to a network mapping constraint (e.g. an NCMI constraint). The resultant modified learning process may be referred to as a CMI constrained deep learning (CMIC-DL) process. In this modified learning process, instead of minimizing the error function (e.g. the average of cross entropy E_{X}[H(P_{Y|X}(⋅|X), qₓ)]) alone, the network mapping function (e.g. NCMI Î(X; Ŷ|Y)) is also considered.

The network mapping constrained optimization problem can be defined as a minimization process (for optimizing the weight parameters θ of the deep neural network) in which the error function is minimized subject to a defined network mapping constraint. For example, the network mapping constrained optimization problem can be defined subject to an NCMI constraint as:

$${min}_{θ} {E}_{X} [ H ( {P}_{Y \vert X} ( \cdot \vert X ) , {q}_{X , θ} ) ] s . t . \hat{I} ( X , \hat{Y} \vert Y ) = r , \qquad ( 27 )$$

where r is a positive constant.

By interpreting the network mapping function (e.g. Î(X; Ŷ|Y) as a rate) and the error function (e.g. E_{X}[H(P_{Y|X}(⋅|X),q_{X,θ})]) as a distortion, the network mapping constrained optimization problem is seen to be similar to the rate distortion problem in information theory (see, for example T. M. Cover, Elements of information theory. John Wiley & Sons, 1999; T. Berger, “Rate distortion theory. englewood clis,” 1971; and E.-H. Yang, Z. Zhang, and T. Berger, “Fixed-slope universal lossy data compression,” IEEE Trans. Inf. Theory, vol. 43, no. 5, pp. 1465-1476, 1997). Rewriting the constraint in (27), and using a Lagrange multiplier method, the constrained optimization problem in (27) can be formulated as the following unconstrained combined optimization problem:

$${min}_{θ} {E}_{X} [ H ( {P}_{Y \vert X} ( \cdot \vert X ) , {q}_{X , θ} ) ] + λ I ( X ; \vert \hat{Y} \vert Y ) - β E [ {I}_{\{ Y \neq V \}} H ( {q}_{X , θ} , {q}_{U , θ} ) ] \qquad ( 28 )$$

where the first hyper-parameter λ>0 is a scalar, and the second hyper-parameter β=λr.

The objective function in (28) is not amenable to parallel computation via GPU due to the dependency of the intra-class concentration I(X; Ŷ|Y) on the centroid s_{y} of each cluster corresponding to Y=y (see equation (19)). To enable parallel computation, the objective function can be converted into a double unconstrained minimization problem by introducing a dummy distribution Q_{y}∈P([C]) (acting as the centroid s_{y} and referred to as below the predicted centroid distribution) for each potential class in the plurality of potential classes y∈[C], as shown below:

### For any λ>0 and β>0,

$${min}_{θ} \text{} \{ {E}_{X} [ H ( {P}_{Y \vert X} ( \cdot \vert X ) , {q}_{X , θ} ) ] + λ I ( X ; \vert \hat{Y} \vert Y ) - β E [ {I}_{\{ Y \neq V \}} H ( {q}_{X , θ} , {q}_{U , θ} ) ] \} = {min}_{θ} {min}_{{\{ {Q}_{c} \}}_{c ϵ [ C ]}} \{ {E}_{X} [ H ( {P}_{Y \vert X} ( \cdot \vert X ) , {q}_{X , θ} ) ] + λ {E}_{X Y} [ D ( {q}_{X , θ} ‖ {Q}_{Y} ) ] - β E [ {I}_{\{ Y \neq V \}} H ( {q}_{X , θ} , {q}_{U , θ} ) ] \} \qquad ( 29 )$$

Given the set of weight parameters θ and the predicted centroid distributions {Q_{c}}_{c∈[C]}, the combined objective function in (29) is now sample additive and can be computed in parallel via GPU. In particular, when the joint distribution P(x,y) is unknown, it can be approximated by its empirical distribution from a plurality of data samples (such as a mini-batch in the DL process [symbol] ={(xᵢ_{₁},yᵢ_{₁}), (xᵢ_{₂},yᵢ_{₂}), . . . , (xᵢ_{ₘ},yᵢ_{ₘ})}. In this case, the expectations in (29) can be approximated by their respective sample means; with P_{Y|X}(⋅|xᵢ_{ⱼ}) replaced by the one-hot probability distribution corresponding to yᵢ_{ⱼ}. The objective function in the double minimization (29) then becomes J [symbol] (λ,β,θ,{Q_{c}}_{c∈[C]}) defined as equation (26).

As noted above, there may be applications in which it is desirable to increase the intra-class concentration value (while maintaining a large inter-class separation value). In such cases, the combined optimization function (28) can be modified for instance, by changing the sign associated with the intra-class concentration term, and the double optimization in (26) and/or (29) can be changed accordingly with a different set of dummy distributions related to {Q_{c}}_{c∈[C]}.

The double optimization function defined in (29) allows for the deep neural network model to be trained using an iterative optimization process that alternates between optimizing the error function and optimizing the network mapping function. By reformulating the single minimization problem as a double minimization problem, an alternating learning algorithm that optimizes the plurality of weight parameters θ and the predicted centroid distributions {Q_{c}}_{c∈[C]} alternatively given that the other is fixed can be used to minimize the objective function in (29).

Optimizing the error function can include updating the plurality of weight parameters in response to inputting the plurality of training data samples into the input layer of the deep neural network. Given a fixed set of predicted centroid distributions {Q_{c}}_{c∈[C]}, the plurality of weight parameters θ can be updated using the same process as in conventional DL through stochastic gradient descent iterations over mini-batches, where the training set (plurality of training data samples) is divided into B mini-batches { [symbol] _{b}}_{b∈[B]} with each batch of size | [symbol] |.

Optimizing the network mapping function, in turn, can be performed while maintaining the plurality of weight parameters θ fixed. For each class in the plurality of potential classes (c∈[C]), the centroid of the set of predicted labels output by the deep neural network can be updated in response to inputting a subset of the training data samples having the associated true label corresponding to that class into the input layer of the deep neural network while maintaining the plurality of weight parameters fixed.

In view of (13) and (37), the optimal predicted centroid distribution {Q_{c}}_{c∈[C]} given a fixed set of weight parameters θ is equal to the centroid s_{c} for the predicted label distributions for a given class, i.e.

$${Q}_{c} = {s}_{c} = {Σ}_{x} {P}_{X \vert Y} ( x \vert c ) {q}_{x , θ} , \qquad ( 30 )$$

for each class in the plurality of potential classes c∈[C].

To update the predicted centroid distribution {Q_{c}}_{c∈[C]} given a fixed set of weight parameters θ, at each iteration, C mini-batches [symbol] _{c∈[C]} can be constructed. The mini-batches [symbol] _{c}, ∀c∈[C], can be generated by, for each particular class c, randomly sampling | [symbol] _{c}| instances from the training samples whose ground truth labels are c (i.e. a subset of the training data samples having the associated true label corresponding to that class). It then follows from (30) that for any class c∈[C], the predicted centroid distribution Q_{c} can be updated as the average value of the predicted label value generated for each training data sample in the mini-batch [symbol] _{c}:

$${Q}_{c} = \frac{{Σ}_{( x , c ) ∈ {𝔅}_{c}} {q}_{x , θ}}{\vert {??}_{c} \vert} . \qquad ( 31 )$$

Optionally, the process of updating {Q_{c}}_{c∈[C]} may use momentum to make the updation more stable and less noisy.

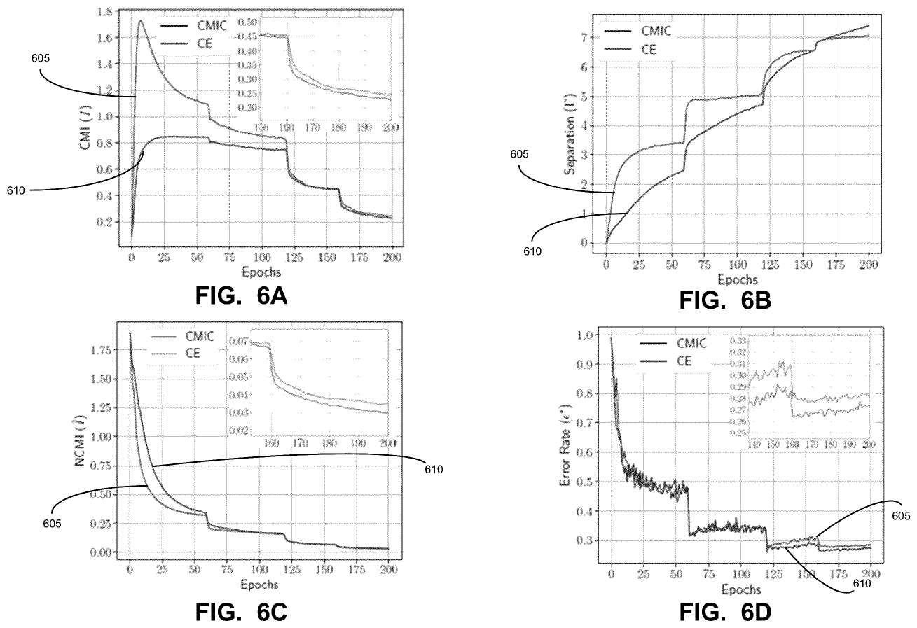

An example of an iterative optimization process 230 that alternates between optimizing the error function and optimizing the network mapping function (i.e. for solving the optimization problem (29)) is described below with reference to FIG. 3B. This example learning algorithm can be seen to converge in FIG. 6 (discussed below). The optimization process can be used to generate a trained deep neural network model, for instance at step 210 of method 200.

In the discussion of method 230, the notation (⋅)_{c,b}^{t} is used to indicate class c at the b-th batch updation during the t-th epoch. The notation (⋅)_{c,B}^{t} can be represented as (⋅)_{c}^{t} whenever necessary, and the values at the beginning of each epoch can be set to (⋅)_{c,0}^{t}=(⋅)_{c}^{t-1}. The training process can be performed using a training set [symbol] , mini-batches { [symbol] }_{b∈[B]}, predefined number of epochs T, and selected values for the hyper-parameters λ, and β.

At 235, the trainable parameters (namely the weight parameters θ and predicted centroid distributions {Q_{c}}_{c∈[C]}) can be initialized by defining initial values θ⁰ and {Q_{c}}_{c∈[C]} for the set of trainable parameters.

An iterative training process 240 can then be performed to update, alternatively, the values of the weight parameters θ and predicted centroid distributions {Q_{c}}_{c∈[C]}). The iterative training process can be performed for epochs t=1 to T. Within each training epoch, the training process can be repeated for each mini-batch b=1 to B.

At 245, the plurality of weight parameters θ can be updated. The plurality of weight parameters can be updated while maintaining the predicted centroid distributions fixed. The predicted centroid distributions can be fixed to the predicted centroid distribution values from the previous batch iteration (i.e. fix {Q_{c,b-1}^{t}}_{c∈[C]}).

The weight parameters for the current batch can then be updated (i.e. update θ_{b-1}^{t} to θ_{b}^{t}) using (stochastic) batch gradient descent over the loss function J [symbol] _{_{b}}(λ,β,θ_{b-1}^{t},{Q_{c,b-1}^{t}}_{c∈[C]}).

At 250, the predicted centroid distributions {Q_{c}}_{c∈[C]} can be updated. The plurality of predicted centroid distributions can be updated while maintaining the weight parameters fixed. The weight parameters can be fixed to the weight parameter values from the current batch (i.e. Fix θ_{b}^{t}) that was used to update the weight parameters in step 245.

A plurality of mini-batches for each class { [symbol] _{c}}_{c∈[C]} can be generated or defined from the training set [symbol] . The predicted centroid distributions can then be updated (i.e. update Q_{c,b-1}^{t} to Q_{c,b}^{t}, ∀c∈[C]) according to equation (31) (here reformulated to reflect the iterative training process):

$${Q}_{c , b}^{t} = \frac{{Σ}_{( x , c ) ∈ {𝔅}_{c}} {q}_{x , {θ}_{b}^{t}}}{\vert {𝔅}_{c} \vert} . \qquad ( 32 )$$

The process can then repeat steps 245 and 250 iteratively until all batches and all training epochs have been completed.

At step 255, the trained weight parameters can be output (i.e. weight parameters θ^{T} can be output).

If the impact of the random mini-batch sampling and stochastic gradient descent is ignored, the alternating process defined in method 230 is guaranteed to converge since given a fixed set of weight parameters θ, the optimal predicted centroid distribution {Q_{c}}_{c∈[C]} can be found analytically via (30), although it may not converge to a global minimum.

Referring again to method 200, at 215 the trained deep neural network can be stored by storing the plurality of trained weight parameters from 210 (e.g. from step 250 of method 230) in one or more non-transitory data storage elements. The trained weight parameters can then be used by the deep neural network when classifying input samples.

### Alternative Inter-Class Separation Functions

As noted herein above, various example inter-class separation functions can be used with the methods described herein to represent the inter-class separation of the DNN: x∈ [symbol] ^{d}→qₓ. In particular, alternative inter-class separation functions, including a second inter-class separation function Γ′ and a third inter-class separation function Γ″ may be used in place of the first inter-class separation function Γ defined in equation (23). As noted above, while the example inter-class separation functions described herein are substantially equivalent, the first inter-class separation function Γ can simplify the selection of hyper parameters in the training methods described herein.

A second example inter-class separation function can be defined as:

$${Γ}^{′} = E [ {I}_{\{ Y \neq V \}} D ( {q}_{X} ‖ {q}_{U} ) ] \qquad ( 33 )$$

The second inter-class separation function can generate a network inter-class separation value based on the relative-entropy D between a plurality of predicted label value pairs (q_{X}, q_{U}). In the second inter-class separation function, the cross entropy function H(q_{X}, q_{U}) in (23) has been replaced by the relative entropy or KL divergence D(q_{X}∥q_{U}). To illustrate the relationship between the second inter-class separation function Γ′ and the intra-class concentration CMI and the first inter-class separation function Γ, the second inter-class separation function Γ′ can be simplified as:

$${Γ}^{′} = E [ {I}_{\{ Y \neq V \}} {\sum }_{i = 1}^{C} {q}_{X} ( i ) ln \frac{{q}_{X} ( i )}{{q}_{U} ( i )} ] = E [ {I}_{\{ Y \neq V \}} {\sum }_{i = 1}^{C} {q}_{X} ( i ) ( ln \frac{{q}_{X} ( i )}{{s}_{Y} ( i )} + ln \frac{{s}_{Y} ( i )}{{q}_{U} ( i )} ) ]$$

$$= E [ {I}_{\{ Y \neq V \}} D ( {q}_{X} ‖ {s}_{Y} ) ] + E [ {I}_{\{ Y \neq V \}} {\sum }_{i = 1}^{C} {q}_{X} ( i ) ln \frac{{s}_{Y} ( i )}{{q}_{U} ( i )} ] \qquad ( 34 )$$

$$= E [ ( 1 - P ( y ) ) D ( {q}_{X} ‖ {s}_{Y} ] + E [ {I}_{\{ Y \neq V \}} {\sum }_{i = 1}^{C} {s}_{Y} ( i ) ln \frac{{s}_{Y} ( i )}{{q}_{U} ( i )} ] \qquad ( 35 )$$

$$= E [ ( 1 - P ( Y ) ) D ( {q}_{X} ‖ {s}_{Y} ) ] + E [ {I}_{\{ Y \neq V \}} D ( {s}_{Y} ‖ {q}_{U} ) ] , \qquad ( 36 )$$

where (35) is due to the fact that V is independent of (X,Y) and given Y, E_{V}[I_{{Y≠V}}]=1−P(Y), and (36) follows from the independence of (X,Y) and (U,V) and (13).

The first expectation value in (36) is related to the intra-class concentration value I(X; Ŷ|Y). When P(Y) is equal to a constant, i.e., 1/C, which is true in most empirical cases, it follows from (18) that

$$E [ ( 1 - P ( Y ) ) D ( {q}_{X} ‖ {s}_{Y} ) ] = ( 1 - \frac{1}{C} ) I ( X , \hat{Y} \vert Y ) ,$$

which, together with (36), implies that

$${Γ}^{′} = ( 1 - \frac{1}{C} ) I ( X , \hat{Y} \vert Y ) + E [ {I}_{\{ Y \neq V \}} D ( {s}_{Y} ‖ {q}_{U} ) ] \qquad ( 37 )$$

Inserting the reformulated second inter-class separation function (37) into the optimization function defined by equation (28) provides the modified optimization function:

$${Min}_{θ} {E}_{X} [ H ( {P}_{Y \vert X} ( \cdot \vert X ) , {q}_{X , θ} ) ] + ( λ - ( β - \frac{β}{C} ) ) I ( X ; \hat{Y} \vert Y ) - β E [ {I}_{\{ Y \neq V \}} D ( {s}_{Y} ‖ {q}_{U , θ} ) ] \qquad ( 38 )$$

As can be seen from the modified optimization function in equation (38), using the second inter-class separation function Γ′ as a measure for inter-class separation would cancel out part of the intra-class concentration value, thus complicating the selection of hyper parameters λ and β.

From the reformulated second inter-class separation function (37) and modified optimization function (38), the inventors have further developed a third example inter-class separation function:

$${Γ}^{″} = E [ {I}_{\{ Y \neq V \}} D ( {s}_{Y} ‖ {q}_{U} ) ] \qquad ( 39 )$$

The third inter-class separation function can generate a network inter-class separation value based on the relative-entropy D between a plurality of predicted label values q_{U} for a first predicted label cluster and the predicted label centroid value s_{Y} for a second predicted label cluster.

The third inter-class separation function Γ″ also provides meaningful geometric information about the mapping structure of the DNN as it measures the average of distances between the output distributions q_{U} of the DNN in response to input sample instances and the centroids s_{Y} of the clusters with different ground truth labels.

To illustrate the relationship between the third inter-class separation function Γ″ and the intra-class concentration CMI and the first inter-class separation function Γ, the third inter-class separation function Γ″ can be simplified as:

$${Γ}^{″} = E [ {I}_{\{ Y \neq V \}} {\sum }_{i = 1}^{C} {q}_{X} ( i ) ln \frac{{s}_{Y} ( i )}{{q}_{U} ( i )} ] = E [ {I}_{\{ Y \neq V \}} H ( {q}_{X} , {q}_{U} ) ] + E [ {I}_{\{ Y \neq V \}} {\sum }_{i = 1}^{C} {q}_{X} ( i ) ln {s}_{Y} ( i ) ] \qquad ( 40 )$$

$$= Γ + E [ {I}_{\{ Y \neq V \}} {\sum }_{i = 1}^{C} {s}_{Y} ( i ) ln {s}_{Y} ( i ) ] \qquad ( 41 )$$

$$= Γ - E [ ( 1 - P ( Y ) ) H ( {s}_{Y} , {s}_{Y} ) ] . \qquad ( 42 )$$

In the above, (40) follows from (34) and (36), (51) is due to (13) and the fact that X is independent of V, and (42) is attributable to the independence of V and Y.

Again, the second term in (42) is related to the intra-class concentration value I(X; Ŷ|Y). When P(Y) is equal to a constant, i.e., 1/C, which is true in most empirical cases, it follows that

$$E [ ( 1 - P ( Y ) ) H ( {s}_{Y} , {s}_{Y} ) ] = ( 1 - \frac{1}{C} ) H ( \hat{Y} \vert Y ) = ( 1 - \frac{1}{C} ) [ I ( X , \hat{Y} \vert Y ) + H ( \hat{Y} \vert X , Y ) ] = ( 1 - \frac{1}{C} ) [ I ( X , \hat{Y} \vert Y ) + H ( \hat{Y} \vert X ) ] \qquad ( 43 )$$

where H(W|Z) denotes the Shannon conditional entropy of the random variable W given the random variable Z, and (43) is due to the Markov chain Y→X→Ŷ. Combining (43) with (42) yields

$${Γ}^{″} = Γ - ( 1 - \frac{1}{C} ) [ I ( X ; \hat{Y} \vert Y ) + H ( \hat{Y} \vert X ) ] \qquad ( 44 )$$

Inserting the reformulated third inter-class separation function (44) into the optimization function defined by equation (28), provides the further modified optimization function:

$${min}_{θ} {E}_{X} [ H ( {P}_{Y \vert X} ( \cdot \vert X ) , {q}_{X , θ} ) ] + ( λ + ( β - \frac{β}{C} ) ) I ( X ; \hat{Y} \vert Y ) + β ( 1 - \frac{1}{C} ) H ( \hat{Y} \vert X ) - βΓ \qquad ( 45 )$$

As can be seen from the modified optimization function in equation (45), using the third inter-class separation function Γ″ as a measure for inter-class separation would further enhance the effect of the intra-class concentration value, again complicating the selection of hyper parameters λ and β.

### Experimental Results

The inventors conducted experiments comparing the results of training deep neural network models using the methods described herein with results of training deep neural network models using known deep learning processes. The performance of the trained deep neural network models was evaluated in terms of accuracy and robustness against adversarial attacks. The results, discussed below, show that deep neural networks trained using the methods described herein outperform the state-of-the-art models trained within the standard DL and other loss functions in the literature in terms of both accuracy and robustness against adversarial attacks.

Experiments were conducted using two popular image classification datasets, namely CIFAR-100 (see A. Krizhevsky, G. Hinton et al., “Learning multiple layers of features from tiny images,” 2009) and ImageNet (see A. Krizhevsky, I. Sutskever, and G. E. Hinton, “Imagenet classification with deep convolutional neural networks,” Advances in neural information processing systems, vol. 25, 2012).

Experiments were conducted on three different model architectural families using the CIFAR-100 dataset. The CIFAR-100 dataset contains 50,000 training and 10,000 test colour images of size 32×32 labeled for 100 classes. In particular (i) three models from the ResNet family were tested (see K. He, X. Zhang, S. Ren, and J. Sun, “Deep residual learning for image recognition,” in Proceedings of the IEEE conference on computer vision and pattern recognition, 2016, pp. 770-778), namely ResNet-{32,56,110}; (ii) the VGG-13 model from the VGG family was tested (see K. Simonyan and A. Zisserman, “Very deep convolutional networks for large-scale image recognition,” in International Conference on Learning Representations, 2015); and (iii) the Wide-ResNet-28-10 model from the Wide-ResNet family was tested (see S. Zagoruyko and N. Komodakis, “Wide Residual Networks,” in British Machine Vision Conference 2016. York, France: British Machine Vision Association, January 2016).

The performance of DNNs trained using the methods described herein was compared against the performance of DNNs trained by existing deep learning processes, including conventional cross entropy loss (CE), center loss (CL) (see Y. Wen, K. Zhang, Z. Li, and Y. Qiao, “A discriminative feature learning approach for deep face recognition,” in Computer Vision-ECCV 2016: 14th European Conference, Amsterdam, The Netherlands, Oct. 11-14, 2016, Proceedings, Part VII 14. Springer, 2016, pp. 499-515) which promotes clustering the features, focal loss (FL) (see T.-Y. Lin, P. Goyal, R. Girshick, K. He, and P. Doll'ar, “Focal loss for dense object detection,” in Proceedings of the IEEE international conference on computer vision, 2017, pp. 2980-2988) which uses regularization, large-margin Gaussian Mixture (L-GM) loss (see W. Wan, Y. Zhong, T. Li, and J. Chen, “Rethinking feature distribution for loss functions in image classification,” in Proceedings of the IEEE conference on computer vision and pattern recognition, 2018, pp. 9117-9126) which imposes margin constraints, orthogonal projection loss (OPL) (see K. Ranasinghe, M. Naseer, M. Hayat, S. Khan, and F. S. Khan, “Orthogonal projection loss,” in Proceedings of the IEEE/CVF international conference on computer vision, 2021, pp. 12 333-12 343) which imposes orthogonality in the feature space, constrained center loss (CCL) (see Z. Shi, H. Wang, and C.-S. Leung, “Constrained center loss for convolutional neural networks,” IEEE transactions on neural networks and learning systems, vol. 34, no. 2, pp. 1080-1088, 2023) which constrain all class centers to the surface of a hypersphere, and hypersphere loss (HL) (see H. Wang, J. Cao, Z.-L. Shi, C.-S. Leung, R. Feng, W. Cao, and Y. He, “Image classification on hypersphere loss,” IEEE Transactions on Industrial Informatics, 2024) which enhances the performance of CCL by ensuring that feature vectors from different categories are adequately separated.

For the training process, an SGD optimizer was deployed with a momentum of 0.9, a weight decay of 0.0005, and a batch size of 64. Models were trained for 200 epochs, and adopted an initial learning rate of 0.1, which was further divided by 10 at epochs 60, 120 and 160. The benchmark training methods were applied using the respective best hyper-parameters reported in their original papers. In addition, in training the models using the methods described herein, training parameters were set to

$${Q}_{c}^{0} ( i ) = \frac{1}{C}$$

for all i, c∈[C], | [symbol] |=8, ∀c∈[C], and Q_{c,b}^{t} was updated using a momentum of 0.9999.

Table 2 shows the validation accuracy of the trained models over the CIFAR-100 dataset. The models were tested over three different random seeds and the results were averaged. In Table 2, bold and underlined values denote the best and second best results, respectively.

TABLE 2
Validation accuracies (%) of different models trained by the methods
described herein (CMIC) and different benchmark methods

| Loss | Res32 | Res56 | Res110 | VGG13 | WRN-28-10 |
|---|---|---|---|---|---|
| CL | 70.23 | 72.70 | 74.20 | 74.50 | 80.97 |
| FL | 71.62 | 73.20 | 74.35 | 74.53 | 81.24 |
| LGM | 71.50 | 73.06 | 74.39 | 74.57 | 81.29 |
| OPL | 71.03 | 72.60 | 73.98 | 74.11 | 81.12 |
| CCL | 71.07 | 73.15 | 74.19 | 74.58 | 81.47 |
| HL | 71.44 | 73.33 | 74.20 | 74.50 | 81.55 |
| CE | 70.90 | 72.40 | 73.79 | 73.77 | 80.93 |
| CMIC | 72.24 | 73.66 | 75.08 | 74.62 | 81.63 |

As can be seen from Table 2, all of the models trained using the methods described herein outperform all of the models trained by the benchmark methods in terms of validation accuracy. Notably, the improvement is consistent across models from different architectural families, showing that the methods described herein can be effectively applied to train DNNs from different families. Compared to training using the CE method, the training methods described herein yield trained DNNs with almost 1.3% higher validation accuracy for the ResNet models.

Table 3 shows the values of the ratio Î(X; Ŷ|Y) between the intra-class concentration and inter-class separation over the validation set of the CIFAR-100 dataset for the same set of models and training methods as in Table 2. The values are averaged over three different runs. In Table 3, Î_{Loss} is used to denote the NCMI value when the underlying DNN is trained using a “Loss” method.

TABLE 3
Ratio between the intra-class concentration and inter-class
separation for different models and training methods

| Loss | Res32 | Res56 | Res110 | VGG13 | WRN-28-10 |
|---|---|---|---|---|---|
| Î_{CL} | 0.057 | 0.045 | 0.0395 | 0.0395 | 0.0309 |
| Î_{FL} | 0.053 | 0.046 | 0.0393 | 0.0399 | 0.0312 |
| Î_{LGM} | 0.054 | 0.047 | 0.0390 | 0.0398 | 0.0310 |
| Î_{OPL} | 0.056 | 0.050 | 0.0397 | 0.0402 | 0.0314 |
| Î_{CCL} | 0.055 | 0.046 | 0.0395 | 0.0399 | 0.0308 |
| Î_{HL} | 0.054 | 0.043 | 0.0394 | 0.0401 | 0.0305 |
| Î_{CE} | 0.057 | 0.053 | 0.0402 | 0.0408 | 0.0317 |
| Î_{CMIC} | 0.051 | 0.042 | 0.0382 | 0.0392 | 0.0303 |

As can be seen from Table 3, Î_{CMIC} has the smallest value compared to models trained using other training methods.

Table 4 sets out the hyper-parameter values for λ* and β* that were used to obtain the best validation accuracies (as shown in Table 2) for the models trained using the methods described herein.

TABLE 4
Hyper-parameters λ* and β* used to train different models

| Params. | Res32 | Res56 | Res110 | VGG13 | WRN-28-10 |
|---|---|---|---|---|---|
| (λ*, β*) | (0.7, 0.4) | (0.7, 0.4) | (0.7, 0.2) | (0.8, 0.3) | (0.7, 0.4) |

As observed, the λ* and β* values are almost the same for all the models.

The inventors also conducted testing using the ImageNet dataset on two models from ResNet family, namely ResNet-18 and ResNet-50. ImageNet is a large-scale dataset used in visual recognition tasks, containing around 1.2 million training samples and 50,000 validation images. The models were trained using the methods described herein as well as the CE and OPL training methods noted above.

For the training process, an SGD optimizer was deployed with a momentum of 0.9, a weight decay of 0.0001, and a batch size of 256. The models were trained for 90 epochs, and adopted an initial learning rate of 0.1, which was further divided by 10 at the 30-th and 60-th epochs. In training the models using the methods described herein, training parameters were set to we set

$${\{ {Q}_{c}^{0} ( i ) \}}_{c ∈ [ C ]} = \frac{1}{C}$$

for i∈[C], | [symbol] |=8, ∀c∈[C], and also Q_{c,b}^{t} was updated using a momentum of 0.9999. The top-{1,5}accuracies for the models trained using the methods described herein and the CE and OPL training methods on the ImageNet dataset are shown in Table 5.

TABLE 5
The validation accuracies (%) of trained deep learning models

| | |
|---|---|
| ResNet-18 | ResNet-50 |

| Method | top-1 | top-5 | top-1 | top-5 |
|---|---|---|---|---|
| CE | 69.91 | 89.08 | 76.15 | 92.87 |
| (Baseline) | | | | |
| OPL | 70.27 | 89.60 | 76.32 | 93.09 |
| CMIC | 70.47 | 89.96 | 76.52 | 93.44 |

As can be seen from Table 5, in comparison with the CE method, the training methods described herein increased the top-1 validation accuracy for ResNet-18 and ResNet-50 by 0.56% and 0.37%, respectively. The improvement is also consistent for the top-5 validation accuracy. The hyper parameters (λ*,β*) used in the training methods described herein for ResNet-18 and ResNet-50 were (0.6,0.1) and (0.6,0.2), respectively. The corresponding NCMI values are Î_{CE}=0.110 and Î_{CMIC}=0.102 for ResNet-18, and Î_{CE}=0.091 and Î_{CMIC}=0.088 for ResNet-50.

To provide a comparison with the results shown in Table 1 herein, the models evaluated in Table 1 were trained using the methods described herein on the CIFAR-100 dataset. The hyperparameters (λ, β) were selected from Table 4 with (0.7,0.4) used for the families WRN and Xception, (0.8,0.3) used for the family Resnext, and (0.7,0.2) used for the rest of families. Table 6 shows the respective intra-class concentration (CMI), inter-class separation (F), ratio (NCMI) of the intra-class concentration to the inter-class separation, and error rate values for the models tested over the CIFAR-100 validation set.

TABLE 6
CMI, Γ, NCMI, and error rate values, over the validation
set, of the models trained using the methods described herein

| | | | | Error | | | | | Error |
|---|---|---|---|---|---|---|---|---|---|
| Model | CMI | Γ | NCMI | rate ϵ* | Model | CMI | Γ | NCMI | rate ϵ* |
| ResNet18 | 0.571 | 10.187 | 0.056 | 0.223 | WRN16_1 | 0.852 | 10.449 | 0.0776 | 0.412 |
| ResNet34 | 0.382 | 10.011 | 0.038 | 0.221 | WRN40_1 | 0.602 | 10.184 | 0.059 | 0.321 |
| ResNet50 | 0.324 | 9.811 | 0.0330 | 0.210 | WRN16_2 | 0.852 | 11.131 | 0.077 | 0.308 |
| ResNet101 | 0.325 | 9.870 | 0.0329 | 0.206 | WRN40_2 | 0.490 | 10.023 | 0.049 | 0.250 |
| ResNet152 | 0.302 | 9.797 | 0.0308 | 0.204 | Xception | 0.194 | 9.570 | 0.020 | 0.215 |
| ResNext50 | 0.303 | 9.850 | 0.0307 | 0.203 | MobileNet-0.25 | 1.018 | 10.830 | 0.094 | 0.395 |
| ResNext101 | 0.289 | 9.763 | 0.030 | 0.201 | MobileNet-0.5 | 0.549 | 9.826 | 0.055 | 0.343 |
| ResNext152 | 0.281 | 9.765 | 0.029 | 0.200 | MobileNet-1 | 0.484 | 9.729 | 0.050 | 0.321 |
| SqueezeNet | 0.987 | 11.599 | 0.085 | 0.299 | DenseNet121 | 0.533 | 10.364 | 0.051 | 0.204 |

In comparison with Table 1, it is clear that both the ratio (NCMI) of the intra-class concentration to the inter-class separation and error rate in Table 6 are smaller than their respective counterparts in Table 1. Again, since models within the same family share the same pair of hyperparameters (λ,β), the same-family phenomenon for Table 1 remains valid for Table 6 as well—as the NCMI value decreases, so does the error rate ∈*. This relationship remains more or less valid for models across families when they share the same pair of hyperparameters (λ,β), save and except that the correlation coefficient ρ is now about 0.85.

The inventors also investigated visualizing the concentration and separation of a DNN, in particular using the CIFAR-100 data set. To visualize concentration and separation of a DNN in a dimension reduced probability space, three class labels were randomly selected. Testing was restricted to a test subset consisting of all validation sample instances with labels from the three selected class labels.

Each validation sample instance from the subset was fed into the DNN. Three logits corresponding to the three selected labels were converted into a 3 dimension probability vector using a softmax operation. The DNN then maps each validation sample instance from the subset into a 3 dimension probability vector. The 3 dimension probability vector is then projected into the 2 dimension simplex. The concentration and separation properties of the DNN for the three selected classes can then be visualized through the projected 2 dimension simplex.

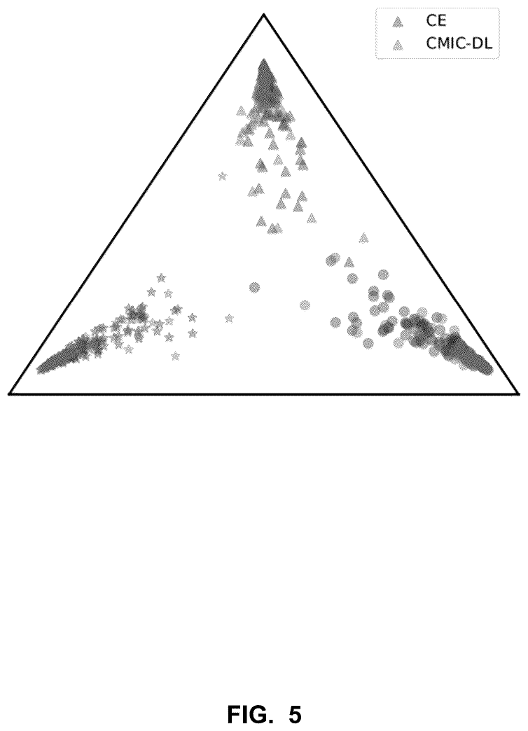

FIG. 5 shows a visualization plot that compares the concentration and separation properties of a ResNet-56 model trained using the methods described herein with those of a ResNet-56 model trained within the standard CE framework. As can be seen in FIG. 5, it is clear that the three predicted label clusters (the darker clusters) generated by the model trained using the methods described herein are more concentrated (i.e. have higher intra-class concentration) than the three predicted label clusters generated by the model trained using the CE learning process, and also further apart from each other (i.e. have greater inter-class separation) than their counterparts in the case of CE. This is consistent with the NCMI values shown in Table 3 above.

The inventors also analyzed the learning process that a deep neural network undergoes when being trained using the methods described herein or the conventional CE-based DL framework. The learning process was analyzed through the lens of intra-class concentration (CMI), inter-class separation (F), ratio (NCMI) of the intra-class concentration to the inter-class separation, and error rate. FIGS. 6A-6D show the evolution curves of CMI, Γ, NCMI, and error rate over the validation set during the course of training ResNet-56 on CIFAR-100 dataset using both the methods described herein (plot lines 610) and the conventional CE-based DL framework (plot lines 605). The models were trained in the same manner as with the models used to generate Table 2 and the hyper-parameters λ=0.7 and β=0.4 were used for the training methods described herein.

As seen in FIG. 6A, the CMI value for the models trained using both CE and the methods described herein is small at the beginning of training (epoch zero). This reflects the clusters in the output probability distribution space P([C]) being close together at the beginning of training, as can also be seen in the separation distance curve in FIG. 6B, and the probability distributions within each cluster are not separated at all. After training starts and for the first few epochs, the clusters move away from each other. During the course of this movement, the probability distributions within each cluster move with different speeds and become separated. As such, the values of both the intra-class concentration CMI and inter-class separation Γ increase as shown in FIGS. 6A and 6B. The clusters then continue to move away from each other, while at the same time, probability distributions within each cluster tend to move closer together. Thus the inter-class separation value Γ continues to increase, while the intra-class concentration value decreases, as shown again in FIGS. 6A and 6B.

The above summarizes the general behaviour of the intra-class concentration CMI and inter-class separation Γ evolution curves for models trained using both the CE learning process and the learning methods described herein. However, as can be seen from FIGS. 6A and 6B, there are also differences in the evolution curves of the models trained using the different learning methods.

For instance, it is clear from FIG. 6A that the intra-class concentration evolution curve for the model trained using the methods described herein always remains below the corresponding evolution curve for the model trained using the conventional CE learning process. From FIG. 6B, it can be seen that although initially the inter-class separation value Γ increases faster in for the model trained using the conventional CE learning process, after the first few epochs, the rate of increase of the inter-class separation value Γ is consistently higher the model trained using the methods described herein than for the conventionally trained model to the extent that its Γ value surpasses its counterpart in the conventionally trained model in the late stage of the learning process.

FIGS. 6C and 6D illustrate convergence in the learning process. It can be seen from FIGS. 6C and 6D, that once the learning process is more or less stabilized, both the NCMI value and error rate of the model trained using the methods described herein are consistently smaller than their counterparts in the conventionally trained model. This is consistent with the results shown in FIG. 2 above, namely that the smaller the NCMI value, the lower the error rate.

The inventors also tested the robustness of DNNs trained using the methods described herein against adversarial attacks as compared to models trained within the standard CE-based DL framework. Because the DNNs trained using the methods described herein result in more compact predicted label clusters in the output probability distribution space, and clusters that are further separated from each other, as compared to models trained within the standard CE-based DL framework, the model robustness is also expected to increase. This increased robustness makes it harder for an adversary to craft a perturbation which, when added to a clean sample, would result in an attacked sample falling into a cluster with a different label.

To test the robustness of the models trained using the disclosed methods, the MNIST dataset (see Y. LeCun, L. Bottou, Y. Bengio, and P. Haffner, “Gradient-based learning applied to document recognition,” Proceedings of the IEEE, vol. 86, no. 11, pp. 2278-2324, 1998) comprising of 10-class handwritten digits was used. A simple DNN with three convolutional layers and one fully connected layer was tested against two white-box attacks, where the adversary has access to the gradients of the underlying model. Specifically, FGSM (see I. J. Goodfellow, J. Shlens, and C. Szegedy, “Explaining and harnessing adversarial examples,” arXiv preprint arXiv:1412.6572, 2014) and PGD attack (see A. Madry, A. Makelov, L. Schmidt, D. Tsipras, and A. Vladu, “Towards deep learning models resistant to adversarial attacks,” in International Conference on Learning Representations, 2018) with 5 iterations were employed with attack perturbation budgets ∥∈∥_{∞}={0.05,0.10,0.15,0.20,0.25,0.30,0.35}.

To train the DNN, an SGD optimizer with a batch size of 64 was deployed. The models were trained for 15 epochs and adopted a step learning rate annealing with decay factor of 0.7. The hyper parameters were selected to be λ*=2 and β*=9 in the training method described herein due to the fact that the classification task over the MNIST dataset is far simpler than that over the CIFAR-100 and ImageNet datasets.

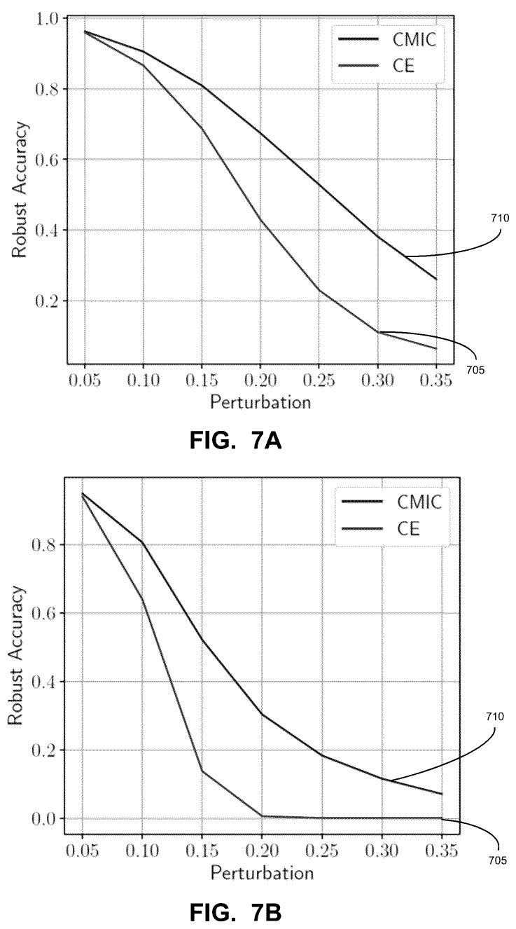

FIGS. 7A-7B illustrate the resulting trade-offs between robust accuracy and perturbation budget for the FGSM attack (FIG. 7A) and PGD attack (FIG. 7B). From FIGS. 7A-7B, it is clear that the DNN trained using the methods described herein (plot lines 710) is more robust against both FGSM and PGD attacks, in comparison with the counterpart model trained within the standard CE-based DL framework (plot lines 705). In addition, the clean accuracy for the models trained using the standard CE-based DL framework and the methods described herein are 99.14% and 99.21%, respectively. This further illustrates that accuracy over benign samples is not sacrificed for a higher model robustness.

While the above description provides examples of one or more methods or apparatuses or systems, it will be appreciated that other methods or apparatuses or systems may be within the scope of the accompanying claims.

It will be appreciated that the embodiments described in this disclosure may be implemented in a number of computing devices, including, without limitation, servers, suitably-programmed general purpose computers, cameras, sensors, audio/video encoding and playback devices, set-top television boxes, television broadcast equipment, mobile devices, and autonomous vehicles. The embodiments described in this disclosure may be implemented by way of hardware or software containing instructions for configuring a processor or processors to carry out the functions described herein. The software instructions may be stored on any suitable non-transitory computer readable memory, including CDs, RAM, ROM, Flash memory, etc.

It will be understood that the embodiments described in this disclosure and the module, routine, process, thread, or other software component implementing the described methods/processes/frameworks may be realized using standard computer programming techniques and languages. The present application is not limited to particular processors, computer languages, computer programming conventions, data structures, other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed embodiments should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method of training a deep neural network, the deep neural network comprising a plurality of layers, the plurality of layers including a plurality of intermediate layers arranged between an input layer and an output layer, wherein the deep neural network is configured to output a predicted label in response to receiving an input value, the method comprising:
inputting a plurality of training data samples into the input layer of the deep neural network, wherein the plurality of training data samples are contained within a training set used to train the deep neural network, wherein each training data sample comprises a training input value, each training input value has an associated true label, and each true label corresponds to a particular class from amongst a plurality of potential classes; and
generating a trained deep neural network using the plurality of training data samples to iteratively optimize both an error function of the deep neural network and a network mapping function of the deep neural network, wherein the network mapping function is defined to represent at least one predicted label distribution geometry property of the predicted labels output by the deep neural network in response to receiving training input values having associated true labels for one or more classes of the plurality of potential classes in the training data samples.

2. The method of claim 1, wherein the at least one predicted label distribution geometry property comprises a network intra-class concentration value for the deep neural network.

3. The method of claim 2, wherein the network intra-class concentration value is defined based on a plurality of class-specific intra-class concentration values, and each class-specific intra-class concentration value represents a relative concentration of the set of predicted labels output by the deep neural network in response to the deep neural network receiving as inputs a set of training input values each having the same associated true label for a specific class in the plurality of potential classes.

4. The method of claim 3, wherein for each potential class, the class-specific intra-class concentration value is determined based on a divergence between the set of predicted labels output by the deep neural network in response to the deep neural network receiving as inputs the set of training input values having the associated true label for that potential class and a centroid of the set of predicted labels.

5. The method of claim 3, wherein the network intra-class concentration value is defined as an average of the class-specific intra-class concentration values for the plurality of potential classes.

6. The method of claim 1, wherein the at least one predicted label distribution geometry property comprises a network inter-class separation value for the deep neural network.

7. The method of claim 6, wherein the network inter-class separation value is defined based on the cross-entropy between a plurality of predicted label value pairs, wherein each predicted label value pair includes a first predicted label value defined based on one or more first predicted labels output by the deep neural network in response to the deep neural network receiving as input one or more first training input values each having a first associated true label for a first specific class and a second predicted label value defined based on one or more second predicted labels output by the deep neural network in response to the deep neural network receiving as input one or more second training input values each having a second associated true label for a second specific class, wherein the first specific class is different from the second specific class.

8. The method of claim 1, wherein the at least one predicted label distribution geometry property comprises a network inter-class separation value and a network intra-class concentration value for the deep neural network, and the network mapping function is defined using a ratio of the network intra-class concentration and the network inter-class separation.

9. The method of claim 1, wherein the at least one predicted label distribution geometry property is approximated based on an empirical distribution of training input value and label pairs in the plurality of training data samples.

10. The method of claim 1, wherein the trained deep neural network model is generated using an iterative optimization process that alternates between optimizing the error function and optimizing the network mapping function.

11. The method of claim 10, wherein the deep neural network comprises a plurality of weight parameters defining layer connections between each pair of adjacent layers in the plurality of layers, and optimizing the error function comprises updating the plurality of weight parameters in response to inputting the plurality of training data samples into the input layer of the deep neural network.

12. The method of claim 10, wherein the deep neural network comprises a plurality of weight parameters defining layer connections between each pair of adjacent layers in the plurality of layers, and optimizing the network mapping function comprises, for each class in the plurality of potential classes, updating the centroid of the set of predicted labels output by the deep neural network in response to inputting a subset of the training data samples having the associated true label corresponding to that class into the input layer of the deep neural network while maintaining the plurality of weight parameters fixed.

13. A computer program product for training a deep neural network, the deep neural network comprising a plurality of layers, the plurality of layers including a plurality of intermediate layers arranged between an input layer and an output layer, wherein the deep neural network is configured to output a predicted label in response to receiving an input value, the computer program product comprising a non-transitory computer readable medium having computer executable instructions stored thereon, the instructions for configuring one or more processors to perform a method of training the deep neural network, wherein the method comprises:
inputting a plurality of training data samples into the input layer of the deep neural network, wherein the plurality of training data samples are contained within a training set used to train the deep neural network, wherein each training data sample comprises a training input value, each training input value has an associated true label, and each true label corresponds to a particular class from amongst a plurality of potential classes; and
generating a trained deep neural network using the plurality of training data samples to iteratively optimize both an error function of the deep neural network and a network mapping function of the deep neural network, wherein the network mapping function is defined to represent at least one predicted label distribution geometry property of the predicted labels output by the deep neural network in response to receiving training input values having associated true labels for one or more classes of the plurality of potential classes in the training data samples.

14. The computer program product of claim 13, wherein the at least one predicted label distribution geometry property comprises a network intra-class concentration value for the deep neural network.

15. The computer program product of claim 14, wherein the network intra-class concentration value is defined based on a plurality of class-specific intra-class concentration values, and each class-specific intra-class concentration value represents a relative concentration of the set of predicted labels output by the deep neural network in response to the deep neural network receiving as inputs a set of training input values each having the same associated true label for a specific class in the plurality of potential classes.

16. The computer program product of claim 15, wherein for each potential class, the class-specific intra-class concentration value is determined based on a divergence between the set of predicted labels output by the deep neural network in response to the deep neural network receiving as inputs the set of training input values having the associated true label for that potential class and a centroid of the set of predicted labels.

17. The computer program product of claim 15, wherein the network intra-class concentration value is defined as an average of the class-specific intra-class concentration values for the plurality of potential classes.

18. The computer program product of claim 13, wherein the at least one predicted label distribution geometry property comprises a network inter-class separation value for the deep neural network.

19. The computer program product of claim 18, wherein the network inter-class separation value is defined based on the cross-entropy between a plurality of predicted label value pairs, wherein each predicted label value pair includes a first predicted label value defined based on one or more first predicted labels output by the deep neural network in response to the deep neural network receiving as input one or more first training input values each having a first associated true label for a first specific class and a second predicted label value defined based on one or more second predicted labels output by the deep neural network in response to the deep neural network receiving as input one or more second training input values each having a second associated true label for a second specific class, wherein the first specific class is different from the second specific class.

20. The computer program product of claim 13, wherein the at least one predicted label distribution geometry property comprises a network inter-class separation value and a network intra-class concentration value for the deep neural network, and the network mapping function is defined using a ratio of the network intra-class concentration and the network inter-class separation.

21. The computer program product of claim 13, wherein the at least one predicted label distribution geometry property is approximated based on an empirical distribution of training input value and label pairs in the plurality of training data samples.

22. The computer program product of claim 13, wherein the trained deep neural network model is generated using an iterative optimization process that alternates between optimizing the error function and optimizing the network mapping function.

23. The computer program product of claim 22, wherein the deep neural network comprises a plurality of weight parameters defining layer connections between each pair of adjacent layers in the plurality of layers, and optimizing the error function comprises updating the plurality of weight parameters in response to inputting the plurality of training data samples into the input layer of the deep neural network.

24. The computer program product of claim 22, wherein the deep neural network comprises a plurality of weight parameters defining layer connections between each pair of adjacent layers in the plurality of layers, and optimizing the network mapping function comprises, for each class in the plurality of potential classes, updating the centroid of the set of predicted labels output by the deep neural network in response to inputting a subset of the training data samples having the associated true label corresponding to that class into the input layer of the deep neural network while maintaining the plurality of weight parameters fixed.

25. A system for training a deep neural network, the deep neural network comprising a plurality of layers, the plurality of layers including a plurality of intermediate layers arranged between an input layer and an output layer, wherein the deep neural network is configured to output a predicted label in response to receiving an input value, the system comprising:
one or more processors; and
one or more non-transitory storage mediums;
wherein
the one or more processors are configured to:
input a plurality of training data samples into the input layer of the deep neural network, wherein the plurality of training data samples are contained within a training set used to train the deep neural network, wherein each training data sample comprises a training input value, each training input value has an associated true label, and each true label corresponds to a particular class from amongst a plurality of potential classes;
generate a trained deep neural network using the plurality of training data samples to iteratively optimize both an error function of the deep neural network and a network mapping function of the deep neural network, wherein the network mapping function is defined to represent at least one predicted label distribution geometry property of the predicted labels output by the deep neural network in response to receiving training input values having associated true labels for one or more classes of the plurality of potential classes in the training data samples; and
store the trained deep neural network in the one or more non-transitory storage mediums.
